(19) United States
(12) Patent Application Publication
(10) Pub. No.: US 2018/0375838 A1
(43) Pub. Date: Dec. 27, 2018

(54) FILTERING AND UNICITY WITH DETERMINISTIC ENCRYPTION

(71) Applicant: salesforce.com, inc., San Francisco, CA (US)

(72) Inventors: Alexandre Hersans, Walnut Creek, CA (US); Assaf Ben Gur, San Francisco, CA (US); Jesse Yarbro Collins, Oakland, CA (US); Shreemanth Karthik Hosahalli Venkateshamurthy, Mountain View, CA (US)

(21) Appl. No.: 15/634,447

(22) Filed: Jun. 27, 2017

(51) Int. Cl. H04L 29/06; G06F 21/62; H04L 9/06

(52) U.S. Cl. CPC H04L 63/0435; G06F 21/6218; G06Q 30/01; H04L 63/102; H04L 9/0618

(57) ABSTRACT

Some database systems may implement encryption services to improve the security of data stored in databases. Certain functionality may or may not be supported depending on the implemented encryption scheme. For example, the encryption service may perform deterministic encryption, which may support filtering and unicity on the resulting ciphertexts. To handle case insensitive filtering, the encryption service may encrypt both a plaintext value and a normalized (e.g., lowercased) plaintext value. A database may perform the case insensitive filtering on the stored ciphertexts corresponding to the normalized plaintext values, but may retrieve the ciphertexts corresponding to the standard plaintext values. To handle a unicity requirement, the database may generate additional unique identifiers to distinguish between duplicate ciphertexts. For example, during a key rotation process, potential duplicates may pass the unicity check based on the unique identifiers, and the database may later fix these potential duplicates.

### FIELD OF TECHNOLOGY

The present disclosure relates generally to database systems and data processing, and more specifically to filtering and unicity with deterministic encryption.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cases, data stored in a database may be encrypted at rest using strong symmetric probabilistic encryption to enhance data security. However, probabilistic encryption may limit the functionality supported for encrypted data fields, especially with respect to querying for the probabilistically encrypted data. For example, the database may not support using probabilistically encrypted data fields for filtering, sorting, or grouping, among other unsupported functions.

### BRIEF DESCRIPTION OF THE DRAWINGS

FIG. 1 illustrates an example of a system for deterministic encryption that supports filtering and unicity with deterministic encryption in accordance with aspects of the present disclosure.

FIGS. 2 and 3 illustrate examples of encryption processes that support filtering and unicity with deterministic encryption in accordance with aspects of the present disclosure.

FIG. 4 illustrates an example of a querying process that supports filtering and unicity with deterministic encryption in accordance with aspects of the present disclosure.

FIG. 5 illustrates an example of a key rotation process that supports filtering and unicity with deterministic encryption in accordance with aspects of the present disclosure.

FIG. 6 illustrates an example of a database storage system that supports filtering and unicity with deterministic encryption in accordance with aspects of the present disclosure.

FIG. 7 illustrates an example of a process flow that supports filtering and unicity with deterministic encryption in accordance with aspects of the present disclosure.

FIGS. 8 and 9 show block diagrams of a device that supports filtering and unicity with deterministic encryption in accordance with aspects of the present disclosure.

FIG. 10 illustrates a block diagram of a system including a application cloud that supports filtering and unicity with deterministic encryption in accordance with aspects of the present disclosure.

FIGS. 11 and 12 show block diagrams of a device that supports filtering and unicity with deterministic encryption in accordance with aspects of the present disclosure.

FIG. 13 illustrates a block diagram of a system including a database system that supports filtering and unicity with deterministic encryption in accordance with aspects of the present disclosure.

FIGS. 14 through 17 illustrate methods for filtering and unicity with deterministic encryption in accordance with aspects of the present disclosure.

### DETAILED DESCRIPTION

A database system and an application cloud may implement encryption to provide additional security for stored data. The application cloud may implement a deterministic encryption scheme or a probabilistic encryption scheme. In some scenarios, when selecting to encrypt data, a user may specify which encryption scheme to implement. In some cases, probabilistic encryption may provide more data security than deterministic encryption, but may support less functionality. To improve supported functionality for encrypted data, the application cloud may implement deterministic encryption that handles filtering processes and unicity requirements.

With regard to filtering, deterministically encrypting plaintext may result in ciphertexts that support case sensitive filtering. Due to the deterministic nature of the encryption process, different ciphertexts may correspond to different plaintexts, while same ciphertexts may correspond to same plaintexts. To filter based on a specific plaintext, the database may filter based on the corresponding ciphertext instead. However, to support case insensitive filtering—such as for Salesforce object query language (SOQL) queries—the application cloud may additionally encrypt a normalized version of the plaintext. For example, the application cloud may lowercase the plaintext, and may encrypt the lowercased plaintext using the same deterministic encryption process as the application cloud used for the standard (i.e., non-normalized) plaintext.

The database system may store both versions of the ciphertext (i.e., the one corresponding to the standard plaintext and the one corresponding to the normalized plaintext). When processing a query including case insensitive filtering criteria (e.g., an equality operation specifying an operand to filter by), the application cloud may normalize the operand, and may modify the query to filter by an encrypted version of the normalized operand. The database system may receive the modified query, and may search the ciphertexts corresponding to normalized plaintexts for any ciphertexts matching the encrypted version of the normalized operand. The database system may return identified data objects, including the ciphertexts corresponding to the standard plaintexts, that match the encrypted version of the normalized operand. In some cases (e.g., if the database system includes ciphertexts encrypted using different encryption keys in a same data field), the database system may search based on multiple encrypted versions of the normalized operand, where each version is associated with one of the different encryption keys.

With regard to unicity, deterministically encrypting plaintext with a single encryption key may result in ciphertexts that support case sensitive unicity. However, to support case insensitive unicity or multiple encryption keys, the database system may store additional information. For example, to handle case insensitive unicity, the database system may store ciphertexts corresponding to normalized versions of plaintexts, similar to the above case insensitive filtering handling. To handle multiple encryption keys (e.g., during a key rotation process), the database system may generate additional unique identifiers. Rather than apply a unicity requirement to just the data field containing the deterministically encrypted data, the database system may apply the unicity requirement to a combination of the data field and the unique identifiers. In this way, if the database system identifies potential duplicates in a data field marked for unicity, the database system may generate (e.g., using a random or pseudorandom process) unique identifiers for each of the potential duplicates. The data field may pass a unicity check based on applying the unicity requirement to the combination of the potential duplicates and the unique identifiers.

Aspects of the disclosure are initially described in the context of an environment supporting an on-demand database service. Further aspects are described with respect to specific processes, such as encryption processes, a querying process, and a key rotation process. A database storage system and a process flow supporting unicity handling for deterministic encryption are then described. Aspects of the disclosure are further illustrated by and described with reference to apparatus diagrams, system diagrams, and flowcharts that relate to filtering and unicity with deterministic encryption.

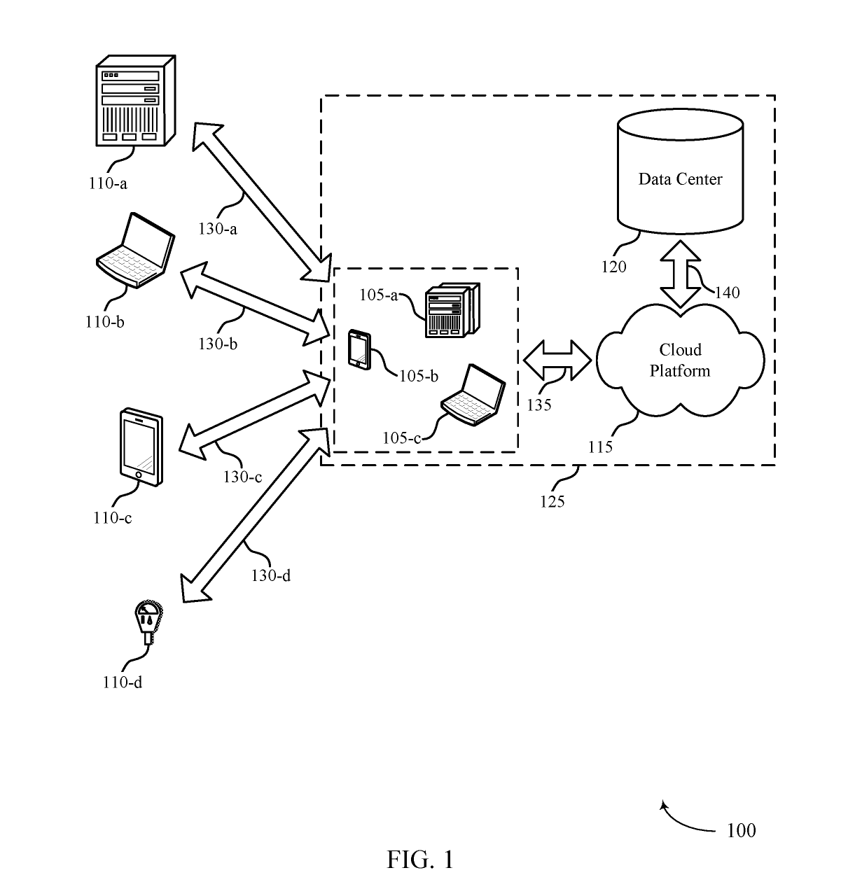

FIG. 1 illustrates an example of a system 100 for cloud computing that supports filtering and unicity with deterministic encryption in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

In some cases, data center 120 may store encrypted data for additional data security. For example, data sent from a cloud client 105 to data center 120 may be encrypted in cloud platform 115 before storage. In some cases, cloud platform 115 and data center 120 may utilize deterministic encryption (e.g., the cloud client 105 may select a deterministic encryption scheme rather than a probabilistic encryption scheme). In some cases, the deterministic encryption scheme may offer more functionality than a probabilistic encryption scheme. For example, data center 120 may support case insensitive filtering on the deterministically encrypted data. Additionally or alternatively, data center 120 may support unicity requirements on the deterministically encrypted data. This functionality may greatly reduce query processing time at cloud platform 115 or data center 120, compared to query processing for probabilistically encrypted data.

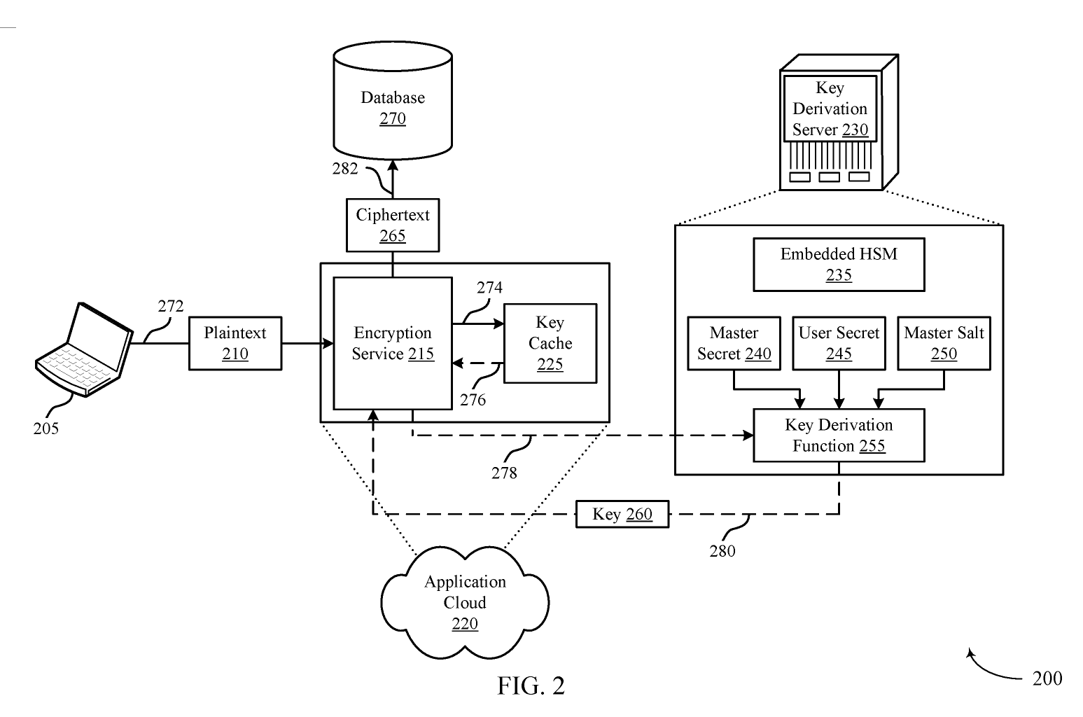

FIG. 2 illustrates an example of an encryption process 200 that supports filtering and unicity with deterministic encryption in accordance with various aspects of the present disclosure. Encryption process 200 may be initiated by a user device 205, which may be an example of a cloud client 105 or a contact 110 as described with reference to FIG. 1. User device 205 may send a data object to a database 270 to be stored. In some cases, the data object may include one or more plaintext data fields that are designated for encryption. The plaintext 210 may be encrypted in an application cloud 220 based on a key 260 generated by a key derivation server 230. In some case, database 270 and key derivation server 230 may be components of a data center 120 as described with reference to FIG. 1. Encryption process 200 may convert the plaintext 210 into ciphertext 265, and may store the ciphertext 265 at database 270.

A database 270 may implement encryption to block users without a certain authorization level from viewing data. Encryption may provide security for data at rest (i.e., data stored at database 270), and may not provide security for data being transmitted or received. In some cases, database 270 may additionally implement security for data being transmitted or received, such as transport layer security. In some cases, a user may turn encryption on or off, and may specify the data for encryption. Some examples of data a user may select to encrypt include personally identifiable information (PII), sensitive, confidential, or proprietary data, or any other data that the user wants to stop unauthorized users from accessing in the database 270. In some cases, the encrypted data may be a data field within a data object, a data file, or an attachment.

In some cases, encryption process 200 may incur a tradeoff between data security and functionality. For example, a user may run functions on data objects in application cloud 220. However, some of these functions may not be designed to run on encrypted data. Encryption process 200 may be an example of probabilistic encryption (i.e., non-deterministic encryption, such as strong symmetric non-deterministic encryption), or may be an example of deterministic encryption. In some cases, probabilistic encryption may support less functionality than deterministic encryption, but may provide enhanced data security. In one example, encryption process 200 may be probabilistic encryption utilizing the Advanced Encryption Standard (AES) with 256-bit keys. Encryption process 200 may additionally use cipher block chaining (CBC), public key cryptography standards (PKCS) for padding (e.g., PKCS #5), a random initialization vector (IV), or any combination thereof. Such an encryption process 200 may be referred to as “Shield Encryption.” In another example, encryption process 200 may be deterministic encryption.

At 272, user device 205 may send a data object to database 270 for storage. The data object may first be sent to application cloud 220, which may include encryption service 215 and key cache 225. The data object may include a set of data fields (e.g., an organization identifier field, a name field, a phone number field, a price field, etc.). In some cases, one or more of the data fields may be designated for encryption. For example, a user may select to encrypt the name field. In some cases, the user may further specify the encryption scheme to utilize (e.g., deterministic or probabilistic). When the data object is received at encryption service 215, a runtime engine may determine whether the data object contains any data designated for encryption. Encryption service 215 may identify the name field, and may initiate encryption of the plaintext 210 corresponding to the name field of the data object.

At 274, encryption service 215 may request an encryption key 260 from key cache 225. The encryption key 260 may be an example of a deterministic encryption key or a probabilistic encryption key 260. An encryption key 260 that was recently used may be stored in key cache 225, which may be an example of an application server cache. For example, when encryption service 215 encrypts data using an encryption key 260, encryption service 215 may store the encryption key 260 in key cache 225. The encryption key 260 may not persist in key cache 225. For example, key cache 225 may flush its storage or remove the encryption key 260 based on a cache replacement algorithm (e.g., a least recently used (LRU) cache algorithm). Key cache 225 may identify whether it contains the encryption key 260 corresponding to the data field to be encrypted and the selected encryption scheme (e.g., based on metadata associated with the data object or the data field). If key cache 225 identifies the encryption key 260, key cache 225 may send the encryption key 260 to encryption service 215 at 276. Otherwise, key cache 225 may send an indication to encryption service 215 that key cache 225 does not have the encryption key 260. In some cases, key cache 225 may not send anything to encryption service 215, and encryption service 215 may determine to derive the encryption key 260 based on not receiving a response from key cache 225.

At 278, encryption service 215 may send a derivation request to a key derivation server 230 based on not receiving the encryption key 260 from key cache 225. Key derivation server 230 may include one or more embedded hardware security modules (HSMs) 235, a master secret 240, a user secret 245, and a master salt 250. The embedded HSMs 235 may be examples of computing devices used to secure and manage any encryption keys 260. The master secret 240 and the master salt 250 may be generated periodically or aperiodically (e.g., at the start of each new software release). The master secret 240 may be generated based on a master HSM, which may be physically located at a different location than key derivation server 230. The user secret 245 may be input by a user or generated on demand based on the embedded HSMs 235. The master secret 240, the user secret 245, the master salt 250, or any combination of these may be input into a key derivation function 255 (e.g., a password-based key derivation function 2 (PBKDF2)). Based on receiving the derivation request, and the master secret 240, the user secret 245, the master salt 250, or a combination of these, the key derivation function 255 may generate an encryption key 260. At 280, key derivation server 230 may send the encryption key 260, which itself may be encrypted, to encryption service 215 or key cache 225.

Encryption service 276 may receive the encryption key 260 (e.g., either from key cache 225 or key derivation server 230) and may use the encryption key 260, along with a random or deterministic IV to encrypt the plaintext 210 into ciphertext 265. Encryption service 215 may then store the encryption key 260 in key cache 225. At 282, the encryption service may store the data object, including the ciphertext 265 for the encrypted data field, in database 270, along with metadata associated with the data field. The associated metadata may include an indication that the data field contains ciphertext 265, an identifier of the user secret 245 used to derive the encryption key 260, and the IV used for encryption.

In some cases, data already stored in database 270 may be selected for encryption. For example, a user may select to turn encryption on for a data field, where one or more data objects stored in database 270 contain the data field. In another example, the user may select to switch encryption schemes for a data field (e.g., from deterministic to probabilistic). In these cases, database 270 may send the data objects or the plaintext 210 stored in the data field to application cloud 220 for encryption. Database 270 may send batches of data objects or data fields for encryption in order to reduce overhead associated with the encryption process at any one time. Additionally, in some cases, encryption may occur in database 270 rather than in application cloud 220.

Encryption process 200 may support separation of duty. That is, encryption process 200 may allow access to encryption keys 260 in the key cache 225 within the application cloud 220, and may not allow access to the encryption keys 260 within database 270. Without access to the encryption keys 260, database 270 may not be able to perform decryption processes on stored ciphertext 265. If the ciphertext 265 is encrypted using probabilistic encryption, the separation of duty may limit the functionality of encrypted data fields. For example, database 270 may not support filtering, sorting, grouping, or some combination of these functions on probabilistically encrypted data fields. Based on these limitations, database 270 or application cloud 220 may not be able to perform one or more processes associated with structured query language (SQL) queries, SOQL queries, list views, reports, or features that may rely on these capabilities (e.g., criteria based sharing, match operations, duplicate record elimination, etc.). Additionally or alternatively, database 270 or application cloud 220 may not be able to apply unicity restrictions to a probabilistically encrypted data field, or use the encrypted data field as an external identifier. In some cases, database 270 or application cloud 220 may perform Salesforce object search language (SOSL) queries on probabilistically encrypted data fields.

Instead of implementing probabilistic encryption, encryption process 200 may implement deterministic encryption. In some cases, a user may opt-in to deterministic encryption for one or more data fields. For example, the user may select (e.g., using user device 205) one or more fields for deterministic encryption. Other data fields may implement probabilistic encryption or may not implement encryption of any type. For example, the user may select to implement deterministic encryption for data fields with lower security protocols (e.g., data fields containing names), and may implement probabilistic encryption for data fields with higher security protocols (e.g., data fields containing social security numbers).

In some cases, application cloud 220 may store encryption keys 260 for deterministic encryption and encryption keys 260 for probabilistic encryption in separate physical locations. For example, application cloud 220 may have a key cache 225 for storing deterministic encryption keys 260, and a separate key cache 225 for storing probabilistic encryption keys 260. Similarly, in some cases, encryption process 200 may include separate key derivation servers 230 for deriving deterministic encryption keys 260 and probabilistic encryption keys 260.

Encryption process 200 may implement one or more functions, code, encryption libraries, ciphertext encoding, or any combination of these to perform deterministic encryption. In some cases, these processes may be the same for deterministic encryption and probabilistic encryption. Performing probabilistic encryption may include generating a random IV, while performing deterministic encryption may include identifying an IV. In some cases, the deterministic encryption service 215 may use a default IV. In other cases, the deterministic encryption service 215 may select an IV based on a data field to be encrypted. The IV may be based on an organization identifier, an entity identifier, a field identifier, or some combination of these identifiers. For example, a data field-specific IV may be based on a hash function using an organization identifier, an entity identifier, and a field identifier as inputs. In this way, deterministically encrypting the same plaintext 210 stored in two different data fields may result in different ciphertexts 265.

Encryption process 200 may include a limited number of active encryption keys 260. For example, when not performing key rotation, database 270 may encrypt all data of a data field using a single encryption key 260. When performing key rotation, application cloud 220 may perform a mass re-encryption process. The mass re-encryption process may include identifying each data object encrypted using an old encryption key 260 (e.g., for a specific data field), and re-encrypting the data for the data objects (e.g., for the specific data field) using a new encryption key 260. In this way, encryption process 200 may remove all instances of the old encryption key 260 (e.g., an archived key) from database 270, and database 270 may once again include a single encryption key 260 (e.g., an active key) for all the data in the data field.

If the ciphertext 265 is encrypted using deterministic encryption, application cloud 220 may support certain functionality on the encrypted data fields. In some cases, this functionality may not be supported for data fields encrypted using probabilistic encryption. For example, application cloud 220 may support filtering capabilities for deterministically encrypted data. In some cases, the supported filtering capabilities may include filtering based on equality, inequality, “where in” clauses, or some combination of these features. In some examples, application cloud 220 may support case sensitive or case insensitive filtering. Additionally or alternatively, application cloud 220 may support unicity for data fields encrypted using deterministic encryption. Application cloud 220 may additionally or alternatively support “group by” functionality in queries, such as SOQL or SQL queries. Moreover, for deterministically encrypted data, application cloud 220 and database 270 may further support aggregation, external identifiers, report filters, list view filters, skinny tables, custom indexes, duplicate record elimination (e.g., using Dedupe), lookup filters, search filters, SOSL “where” clauses, merges, import/export wizard filters, bounced emails, email integrations (e.g., Salesforce for Outlook), criteria based sharing, match functionality, or any combination of these capabilities.

Encryption process 200 implementing deterministic encryption may have multiple differences at a metadata level from an encryption process implementing probabilistic encryption. Encryption process 200 may include a deterministic option for encryption enablement. Encryption process 200 may include an encryption enablement interface in the code, which may identify the set of data fields to be encrypted. The encryption enablement interface may support selecting a subset of data fields of the identified set of data fields for deterministic encryption. The encryption enablement interface may support both deterministically encrypting the selected subset of data fields and probabilistically encrypting one or more unselected data fields of the set of data fields. In addition to the code interface, encryption process 200 may include a user interface (e.g., at user device 205) for the deterministic option. A user may select the data fields or sets of data fields for deterministic encryption using the user interface. In some cases, such a user interface may be included in a custom field wizard, in a field enablement page, or in some other user device 205 display. Database 270 may store an additional bit, which may be referred to as an option bit, to identify whether a data field uses a default encryption scheme (e.g., a probabilistic encryption scheme) or a different encryption scheme (e.g., a deterministic encryption scheme). For example, each data field in database 270—or each encrypted data field in database 270—may include an associated “UseDeterministicEncryption” option bit to track the encryption scheme for the data field. In one example, a 0 bit value may indicate the default encryption scheme, while a 1 bit value may indicate a different encryption scheme.

Encryption process 200 may include one or more encryption validators. When performing encryption process 200, application cloud 220 may run each encryption validator to determine whether the data, and corresponding metadata, to be encrypted is encryption compatible. If an encryption validator identifies an encryption incompatibility, the encryption validator may stop the encryption process and, in some cases, may send an indication to user device 205 that the encryption process has failed. Running the encryption validators may be based on the encryption scheme selected for the encryption process. For example, an encryption validator that blocks encryption enablement based on filtering support may determine whether data is selected to be deterministically encrypted or probabilistically encrypted. In some cases, the encryption validator may block probabilistic encryption enablement based on the filtering criteria, but may not block deterministic encryption enablement.

Some examples of encryption validators may validate old lead convert processes, portal processes, skinny tables, criteria based sharing, custom indexes, code (e.g., Apex) compilation, flow, custom formula fields, or some combination of these. Many of these encryption validators may operate in the same manner for deterministically and probabilistically encrypted data, while others may be modified based on the selected encryption scheme. For example, a custom formula field encryption validator may utilize an additional bit to indicate additional information about a custom formula field (e.g., that the custom formula field is filterable and groupable, but not sortable) for deterministic encryption.

In some cases, application cloud 220, or database 270, may determine whether to run encryption validators when switching from one encryption scheme to another. For example, when switching from a probabilistic encryption scheme to a deterministic encryption scheme, application cloud 220 may determine that encryption functionality restrictions are relaxed from the probabilistic scheme to the deterministic scheme. Due to the relaxing of restrictions, application cloud 220 may not run a set of encryption validators when performing this encryption scheme modification. However, when switching from a deterministic scheme to a probabilistic scheme, application cloud 220 may run one or more encryption validators, as the switch may introduce additional encryption functionality restrictions. When switching an encryption scheme, database 270 may indicate (e.g., using a “MightHaveMixedData” bit) that the data field may contain mixed data (e.g., data encrypted using different encryption schemes, or some encrypted data and some unencrypted data). For example, database 270 may set the bit value to 1 if the data field may contain mixed data, and may set the bit value to 0 if the data in the data field has been cleaned (e.g., using a mass encryption process) and contains data of a single encryption scheme.

Encryption process 200 may manage encryption keys 260 differently based on whether the encryption keys 260 are examples of deterministic encryption keys 260 or probabilistic encryption keys 260. In some cases, key derivation server 230 may generate deterministic encryption keys 260 using a different user secret 245 type, which may be referred to as a tenant secret flavor, than when generating probabilistic encryption keys 260. For deterministic encryption keys 260, database 270 may implement key rotation timing thresholds. Additionally or alternatively, database 270 may implement a minimum delay between two key rotations, a maximum delay between two key rotations, a set timing delay between two key rotations, or some combination of these. During a key rotation process, application cloud 220 may perform a mass re-encryption, and may destroy any old encryption keys 260 following the mass re-encryption. Database 270 may retain a single encryption key 260 (e.g., on a per-data field basis) when not performing a key rotation procedure. In some cases, a user may destroy a deterministic encryption key 260 without first re-encrypting the data with another encryption key 260. In these cases, the user may lose access to any data encrypted using the destroyed deterministic encryption key 260.

In some cases, encryption process 200 may be similar for deterministic encryption and probabilistic encryption. For example, encryption service 215 may use a same code and formulas to generate ciphertext 265 based on plaintext 210, an encryption key 260, and an initialization vector (IV). In some cases, the difference between deterministic and probabilistic encryption may be in generating deterministic encryption keys 260 rather than probabilistic encryption keys 260—as described above—and generating a deterministic IV rather than a probabilistic IV. For example, to generate a probabilistic IV, encryption service 215 may randomly generate the IV (e.g., using a pseudorandom number generator (PRNG) or deterministic random bit generator (DRBG)). In contrast, to generate a deterministic IV, encryption service 215 may use a hash (e.g., a secure hashing algorithm (SHA), such as SHA-256) to generate the IV. In one example, the encryption service 215 may concatenate an organization identifier, an entity identifier, a data field identifier, or some combination of these identifiers associated with the plaintext 210, and may input the concatenated value into an SHA to obtain the IV as an output. In some cases, the IVs generated randomly and the IVs generated using a hash may share a common format.

Encryption process 200 may modify a data dictionary, such as the universal data dictionary (UDD), to include information associated with the encryption schemes. For example, the UDD may indicate one or more characteristics of a data field during processing (e.g., programmatically, at runtime) of a query. The characteristics may correspond to different functionality supported for data fields, which may depend on whether the data fields are encrypted using deterministic or probabilistic encryption. For a query, the UDD may indicate selectability, filterability, sortability, groupability, or some combination of these characteristics. The selectability of a data field may refer to whether a value of the data field may be retrieved. In some cases, deterministic encryption and probabilistic encryption may not affect the selectability of a data field. The filterability of a data field may refer to whether the value of the data field may be used as a condition on the data to be retrieved. For example, a query may containing a filter expression, which may include one or more of a set of operators. A data field may support using the value of the data field as a condition for some operators (e.g., equals or contains operators). In some cases, the encryption scheme (e.g., deterministic or probabilistic) or the type of data object may determine the supported set of operators. The sortability of a data field may refer to whether the values of the data field may be ordered when retrieved by a query. The groupability of a data field may refer to whether the values of the data field may be grouped when retrieved by a query, eliminating duplicate data objects. Similarly, groupability may correspond to whether the data field is aggregatable (e.g., whether a sum or a count operation may be performed on the values of the data field).

Database 270 may support multiple different types of queries. For example, database 270 may perform a query process based on a SOQL query, a list view, a report, or any other operation that searches database 270 to retrieve data values. In some cases, the UDD may indicate characteristics of a data field based on Boolean methods (e.g., isApiSortable( ) or isListViewFilterable( )). The UDD may determine the characteristics based on property definitions at the common layer level (e.g., based on the data type of the data field), specific attributes defined at the extensible markup language (XML) level, or some combination of these definitions. For example, a text data field may be automatically specified as filterable in SOQL at the common layer level. In some specific cases, the isApiFilterable attribute may be set to false in an XML definition file, which may override the definition at the common layer level.

However, to support encrypted data fields, the capabilities may be specified in the information layer rather than the common layer. For example, the capabilities may be based on an encryption scheme in addition to a data type. For example, a probabilistically encrypted data field may not support filtering, sorting, or grouping. Additionally, any custom field directly or indirectly referencing an encrypted data field may follow the same capability restrictions as the encrypted data field. Furthermore, the filterability, sortability, or both of external custom fields may be based on information in a corresponding external system. For custom fields on custom big objects, the filterability may be based on whether the custom fields are part of a composite primary key for the custom big object. In the information layer, the capabilities may be specified based on an encryption scheme used, organization or tenant specific information about a data field, custom field specific information, or any combination of these.

Boolean methods related to data field capabilities may be consolidated in the information layer into a set of methods defined in DescribeUtils. For example, DescribeUtils may include information corresponding to isApiFilterable( ) isApiSortable( ), isApiGroupable( ) isAggregatable( ) or any combination of these. Additionally, DescribeUtils may include the corresponding methods for list views, reports, or both. The data field capabilities may be based on an organization or tenant identifier, and may differ on an operation-by-operation or function-by-function basis. For example, a deterministically encrypted data field in database 270 may support some filtering functions (e.g., the equality operator) and may not support other filtering functions (e.g., the contains operator). In this way, data field capabilities may be encryption, custom field, or tenant driven in addition to data type driven. The logic may additionally be propagated in the application program interface (API), which may allow list views to display relevant supported operators in a user interface.

Implementing deterministic encryption for encryption process 200 may support some filtering capabilities. In some cases, switching from probabilistic encryption to deterministic encryption may unlock these filtering capabilities. To perform filtering based on a deterministically encrypted ciphertext 265, encryption service 215—or some similar service—may convert plaintext 210 in a query into ciphertext 265. For example, database 270 may process the following SOQL query:

Select Id From Account Where Name=‘Account Name’

Based on a deterministic encryption process, a query builder may determine the ciphertext 265 corresponding to “Account Name” (e.g., “\uFFFEEBxx0000005LGW”). The query builder may modify the original query to instead query for the ciphertext 265, rather than the plaintext 210. In some cases, the query builder may also modify a tenant identifier (e.g., “Tenant_Name”) to search for a corresponding ciphertext 265 version of the tenant identifier (e.g., “sQZFFRL2xyl4plS089\T”). For example, the above SOQL query may be converted to the following SQL query:

SELECT account_id
FROM sales.account
WHERE organization_id = ‘sQZFFRL2xy14plS089\T’
AND name = ‘\uFFFEEBxx0000005LGW’;

Similarly, the query builder may support modifying SOQL queries with inequality (i.e., <> or !=) or “where in” operators that reference deterministically encrypted data into SQL queries.

In some cases (e.g., during a key rotation process), database 270 may contain multiple different ciphertexts 265 corresponding to a same plaintext 210. In such cases, the query builder may modify the original query to instead query for a set of possible ciphertexts 265 corresponding to the plaintext 210 (e.g., where each of the set of possible ciphertexts 265 is associated with a different deterministic encryption key 260, deterministic IV, or both). The query builder may convert the equality operator to a “where in” operator to handle the multiple ciphertexts 265 for filtering.

Database 270 may perform the above process if database 270 implements case sensitive filtering. However, in many cases, database 270 may implement case insensitive filtering for SOQL queries (e.g., filtering by “filter” will return any matching values regardless of case, such as “Filter,” “FILTER,” “FiLTer,” etc.). For plaintext 210 data, the query builder may handle case insensitive filtering by lowercasing the right operand (i.e., the filtering criteria) and performing a lowercasing function on the data field values. For example, the above SOQL query may be converted to the following case insensitive SQL query without managing encryption:

SELECT account_id
FROM sales.account
WHERE organization_id = ‘Tenant_Name’
AND lower(name) = ‘account_name’;

However, such a strategy may not work for encrypted data, as lowercasing “\uFFFEEBxx0000005LGW” will not result in filtering by “account_name.”

To handle case insensitive filtering on deterministically encrypted data, encryption service 215 may encrypt a normalized version of plaintext 210. For example, to store a case insensitive filterable custom field, database 270 may store two fields: a first field containing ciphertext 265 corresponding to the plaintext 210 (e.g., to capture the exact value provided by user device 205), and a second field containing ciphertext 265 corresponding to a normalized (e.g., lowercased or uppercased) version of the plaintext 210. The two fields may be associated in database 270 (e.g., in the UDD, or using one or more reference bits). In some cases, if a tenant has a limited number of custom fields available, such a case insensitive filterable custom field may count as two custom fields towards the limit. To store a case insensitive filterable standard field, encryption service 215 may implement a similar technique. The ciphertext 265 corresponding to the plaintext 210 may be stored in a standard field table, while the ciphertext 265 corresponding to the normalized plaintext 210 may be stored in an additional field of the standard field table, or in an additional field of a custom field table. In some cases, the custom fields, standard fields, or both may have localized entry points for querying and create, read, update, and delete (CRUD) operations.

An encryption process 200 implementing deterministic encryption may additionally or alternatively support unicity. A user may mark a data field as have unicity requirement (e.g., using a user interface). As such, database 270 may not store a same value in a unique data field for two data objects. In some cases, a unique data field may be an example of a case sensitive unique data field. In these cases, if the unique data field is deterministically encrypted, database 270 may not store the same ciphertext 265 in the data field for more than one data object, as different deterministic ciphertexts 265 may correspond to different case sensitive plaintext 210 values.

In other examples, a unique data field may be an example of a case insensitive unique data field. To handle a case insensitive unicity requirement, database 270 may once again store ciphertext 265 corresponding to a normalized version of the plaintext 210 in an additional data field. Database 270 may apply the unicity requirement to this additional data field rather than the data field storing the ciphertext 265 corresponding to the plaintext 210. In some cases, database 270 may store the ciphertext 265 corresponding to the normalized version of the plaintext 210 in a custom index table, where the normalized version of the plaintext 210 may be associated with a unique index (e.g., an Oracle unique index). In these cases, database 270 may perform custom index management within database triggers to support encryption and decryption.

Database 270 may handle unicity requirements on deterministically encrypted fields during key rotation processes by implementing additional unique identifiers. Database 270 may apply the unicity requirement to the combination of the data field and the unique identifier field. For example, when performing key rotation, the same plaintext 210 may correspond to multiple ciphertexts 265 (e.g., due to the multiple encryption keys 260 in use). Based on this, database 270 may store multiple encrypted versions of the same plaintext 210 in a unique data field. During a mass re-encryption process with the new encryption key 260, database 270 may store multiple versions of the same ciphertext 265 in the unique data field. In order to meet the unicity requirement, database 270 may store a different unique identifier for each of the same ciphertexts 265. By applying the unicity requirement to both of the fields, database 270 may continue the mass re-encryption process despite storing multiple duplicates of data in the unique data field. After the mass re-encryption process, database 270 may fix any duplicates (e.g., by deleting one or more of the duplicates).

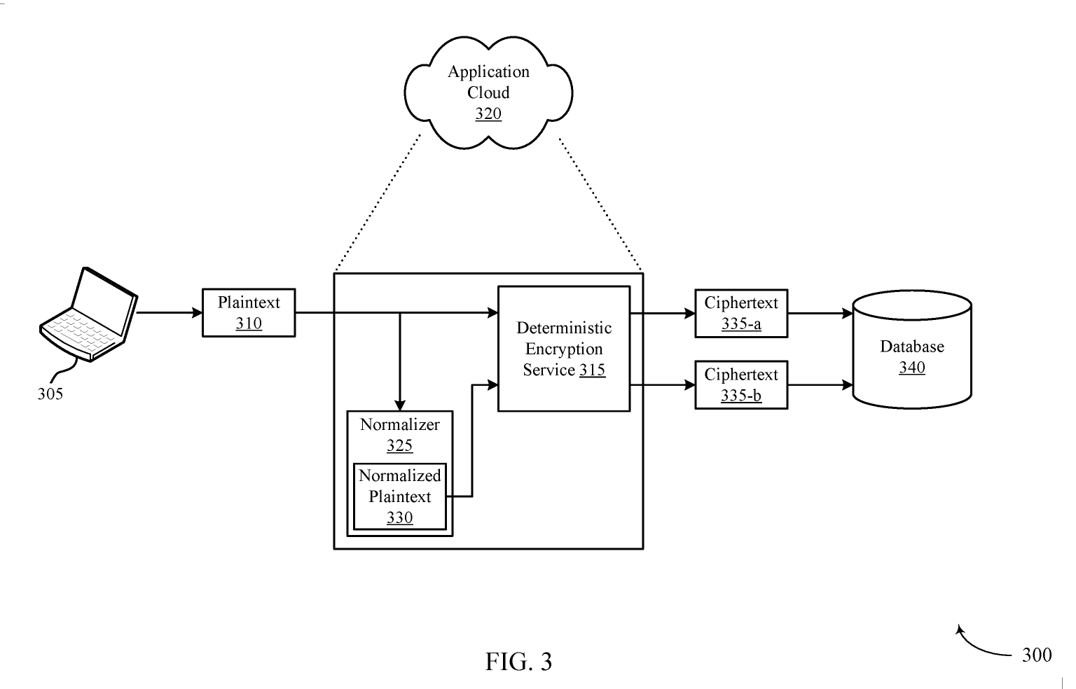

FIG. 3 illustrates an example of an encryption process 300 for handling case insensitivity that supports filtering and unicity with deterministic encryption in accordance with various aspects of the present disclosure. Encryption process 300 may include user device 305 sending plaintext 310 to application cloud 320 for encryption and storage in database 340. User device 305 may be an example of a cloud client 105 or contact 110, application cloud 320 may be an example of a cloud platform 115 or application cloud 220, and database 340 may be an example of a data center 120 or database 270 as described with reference to FIGS. 1 and 2. Application cloud 320 may include deterministic encryption service 315 and normalizer 325. Encryption process 300 may support handling case insensitivity, for both filtering and unicity.

User device 305 may send plaintext 310 to application cloud 320 for storage. Plaintext 310 may include a mix of uppercase and lowercase characters (e.g., “PlainText”). Application cloud 320 may determine that plaintext 310 corresponds to a data field marked for deterministic encryption. In other cases, user device 305 may select to deterministically encrypt data already stored in database 340. For example, the data may be stored as plaintext 310, or may be probabilistically encrypted. In these cases, database 340 may send the data to application cloud 320 for deterministic encryption. If the data is probabilistically encrypted, application cloud 320 may first decrypt the data to obtain plaintext 310, and then may perform deterministic encryption.

At application cloud 320, plaintext 310 may be normalized by normalizer 325. For example, normalizer 325 may lowercase plaintext 310 to obtain normalized plaintext 330. Normalizer 325 may take PlainTexf as input, and may output ‘plaintext.’ Both plaintext 310 and normalized plaintext 330 may be sent to deterministic encryption service 315. Deterministic encryption service 315 may encrypt plaintext 310 and normalized plaintext 330 using a deterministic encryption key, which may be an example of an encryption key 260 as described with reference to FIG. 2, and a deterministic IV. Deterministic encryption service 315 may encrypt plaintext 310 into ciphertext 335-a and normalized plaintext 330 into ciphertext 335-b. Application cloud 320 may send both ciphertexts 335 to database 340, and database 340 may store both ciphertexts 335. For example, database 340 may store ciphertext 335-a in a first data field, and may store ciphertext 335-a in a normalized second data field. Database 340 may contain an indication associating the first data field and the normalized second data field. When performing case insensitive processes (e.g., filtering, unicity, etc.), database 340 may use the normalized second data field and ciphertext 335-b for the case insensitive processes.

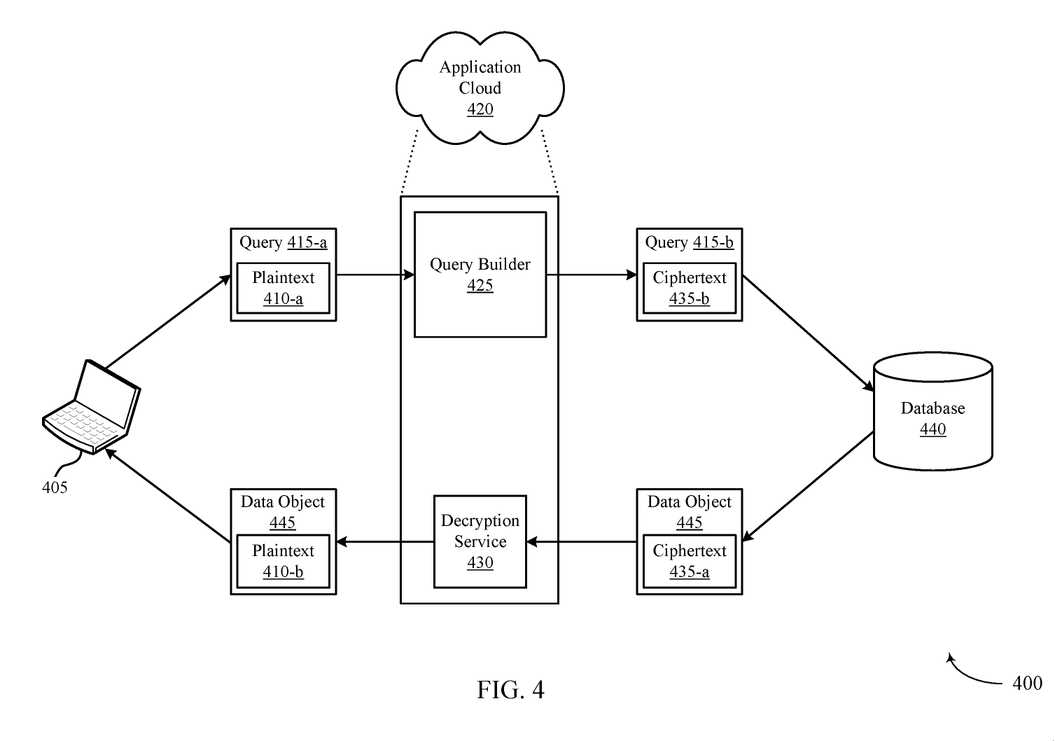

FIG. 4 illustrates an example of a querying process 400 that supports filtering and unicity with deterministic encryption in accordance with various aspects of the present disclosure. Querying process 400 may include user device 405, application cloud 420, and database 440, which may be examples of the corresponding devices as described with reference to FIGS. 2 and 3. In querying process 400, user device 405 may query for data objects 445, where a first data field of the data objects 445 contains plaintext 410-a, or a case insensitive version of plaintext 410-a. However, database 440 may store deterministically encrypted data in the first data field.

User device 405 may send query 415-a to database 440, through application cloud 420. Query 415-a may be an example of a SOQL or SQL query, and may include an indication of plaintext 410-a for filtering (e.g., as the operand in an equality operation) on the first data field. In application cloud 420, query builder 425 may convert query 415-a for use at database 440. For example, if query 415-a is a SOQL query, query builder 425 may convert query 415-a to a SQL query (e.g., query 415-b). Additionally, query builder 425 may determine a ciphertext 435 for filtering based on plaintext 410-a. For case insensitive filtering, query builder 425 may first normalize (e.g., lowercase) plaintext 410-a, and then may use a deterministic encryption service to determine ciphertext 435-b corresponding to the normalized version of plaintext 410-a. In some cases (e.g., during a key rotation process), query builder 425 may determine multiple ciphertexts 435 corresponding to the normalized version of plaintext 410-a.

Application cloud 420 may send query 415-b to database 440. Based on query 415-b, and the indicated ciphertext 435-b, database 440 may determine any data objects 445 matching the filtering criteria. For example, database 440 may search a normalized data field associated with the first data field for any instances of ciphertext 435-b. If database 440 identifies a data object 445 with ciphertext 435-b in the normalized data field, database 440 may send the data object 445 back to application cloud 420. However, instead of sending ciphertext 435-b contained in the normalized data field with the data object 445, database 440 may send ciphertext 435-a contained in the associated first data field. In this way, database 440 may return the encrypted actual plaintext 410, rather than the encrypted normalized version of the plaintext.

In application cloud 420, decryption service 430 may decrypt the deterministically encrypted data in data object 445. For example, decryption service 430 may decrypt ciphertext 435-a using an associated deterministic encryption key and deterministic IV. Decrypting ciphertext 435-a may result in plaintext 410-b, which may be a case insensitive version of plaintext 410-a. For example, plaintext 410-a and 410-b may contain the same characters, but the characters may not match cases. That is, in one example, plaintext 410-a may contain ‘PlainText,’ and plaintext 410-b may contain ‘plainText.’ Application cloud 420 may send data object 445, along with the decrypted data fields, to user device 405. In some cases, user device 405 may display the data object 445 retrieved based on query 415-a to a user in a user interface.

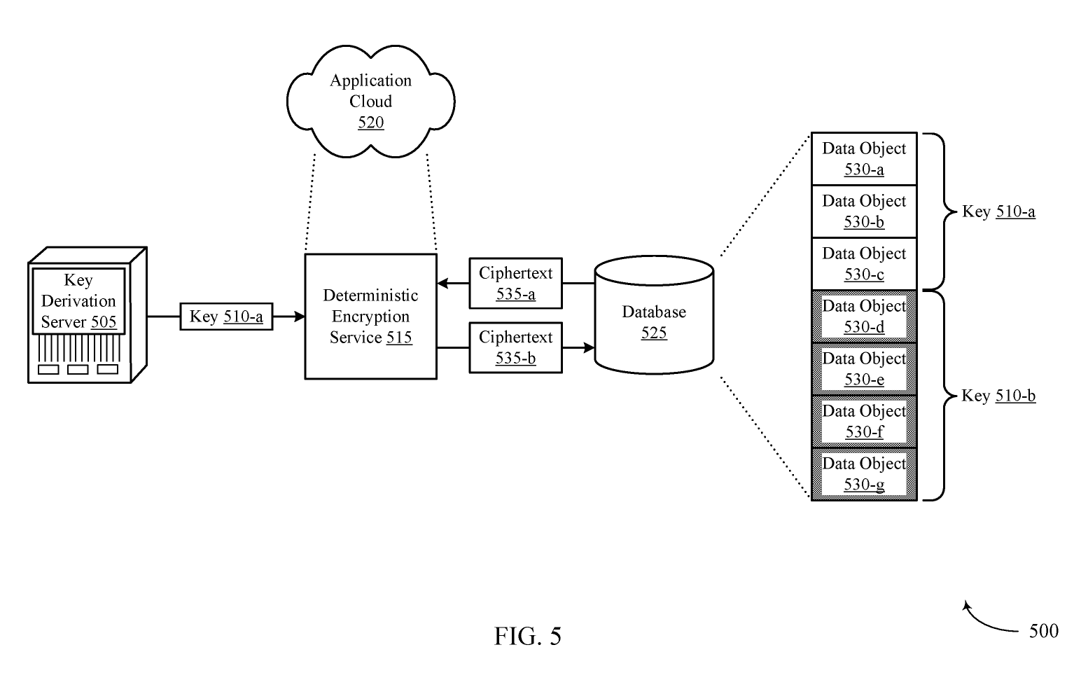

FIG. 5 illustrates an example of a key rotation process 500 that supports filtering and unicity with deterministic encryption in accordance with various aspects of the present disclosure. Key rotation process 500 may include key derivation server 505, which may be an example of the key derivation server 230 as described with reference to FIG. 2. Additionally, key rotation process 500 may include application cloud 520 and database 525, which may be examples of a cloud platform 115 or an application cloud 220, 320, or 420 and a data center 120 or database 270, 340, or 440 as described with reference to FIGS. 1 through 4. Key rotation process 500 may be an example of a standard deterministic key rotation, or may be an example of a mass encryption or re-encryption process.

In a first example, data objects 530 stored in database 525 may use a first deterministic encryption key 510-b for encrypting a first data field. Key derivation server 505 may generate a new encryption key 510-a, and may send new encryption key 510-a to application cloud 520. In some cases, key derivation server 505 may generate new encryption key 510-a based on a user input (e.g., the user may select to rotate the keys 510 used to encrypt the first data field). In other cases, key derivation server 505 may generate new encryption key 510-a based on a time interval. For example, key derivation server 505 may generate encryption key 510-b at a first time, and may automatically generate new encryption key 510-a after a predetermined time interval has passed since the first time. In some cases, a user may select the time interval.

Database 525 may send ciphertext 535-a to application cloud 520 for re-encryption using new encryption key 510-a. Ciphertext 535-a may be an example of ciphertext 535 stored in the first data field for a data object 530, such as data object 530-c. In application cloud 520, deterministic encryption service 515 may receive new encryption key 510-a and ciphertext 535-a as inputs. Deterministic encryption service 515 may retrieve first encryption key 510-b (e.g., from a key cache or from key derivation server 505) and may decrypt ciphertext 535-a using first encryption key 510-b, a deterministic IV, or both to obtain a corresponding plaintext value. Deterministic encryption service 515 may then re-encrypt the corresponding plaintext value using new encryption key 510-a, and in some cases a deterministic IV (e.g., the same deterministic IV, or a different deterministic IV). Based on the re-encryption, deterministic encryption service 515 may obtain ciphertext 535-b, and may send ciphertext 535-b back to database 525. Database 525 may store ciphertext 535-b in the first data field for the associated data object 530, such as data object 530-c. Database 520 may also store an indication of the encryption key 510 used to encrypt each data field. For example, at this point in key rotation process 500, data objects 530-a, 530-b, and 530-c may have the first data field encrypted using new encryption key 510-a, while data objects 530-d, 530-e, 530-f, and 530-g may have the first data field encrypted using first encryption key 510-b. In some cases, database 525 may send batches of ciphertext 535 to application cloud 520 for re-encryption (e.g., database 525 may send ciphertext 535 associated with the first data field for data objects 530-d, 530-e, 530-f, and 530-g to deterministic encryption service 515 for re-encryption).

In a second example, data objects 530 stored in database 525 may contain probabilistically encrypted data in a first data field. A user may select to re-encrypt that first data field using deterministic encryption. Key derivation server 505 may generate a deterministic encryption key 510-a, and may send deterministic encryption key 510-a to deterministic encryption service 515. Database may send ciphertext 535-a or batches of ciphertexts 535 to application cloud 520. Application cloud 520 may retrieve probabilistic encryption key 510-b, or a set of probabilistic encryption keys 510, to decrypt the ciphertexts 535. Deterministic encryption service 515 may then re-encrypt the data using deterministic encryption key 510-a, and may send the corresponding ciphertext 535-b or batches of ciphertexts 535 back to database 525. In some cases, data objects 530 with the first data field encrypted using deterministic encryption (e.g., data objects 530-a, 530-b, and 530-c) may support different functionality than data objects 530 with the first data field encrypted using probabilistic encryption (e.g., data objects 530-d, 530-e, 530-f, and 530-g). For example, database 525 may filter based on the first data field for data objects 530-a, 530-b, and 530-c, and in some cases may not filter on the first data field for the other data objects 530. Database 525 may store information about the capabilities associated with deterministically encrypted data fields, the capabilities associated with probabilistically encrypted data fields, or both sets of capabilities in a metadata repository, such as the UDD.

In a third example, data objects 530 stored in database 525 may contain plaintext in a first data field. A user may select to encrypt the data stored in the first data field using deterministic encryption. In this case, database 525 may not send ciphertext 535-a to deterministic encryption service 515, but may instead send plaintext to deterministic encryption service. Key derivation server 505 may send a deterministic encryption key 510-a to deterministic encryption service 515, and deterministic encryption service 515 may encrypt the plaintext using deterministic encryption key 510-a to obtain ciphertext 535-b. Application cloud 520 may send ciphertext 535-b to database 525 to be stored in the first data field. In some cases, deterministic encryption service 515 may encrypt batches of plaintext. In this way, the first data field for data objects 530 may be mass encrypted using deterministic encryption key 510-a. During the process, database 530 may store an indication of data objects 530 with the first data field encrypted, and data objects 530 with the first data field not yet encrypted.

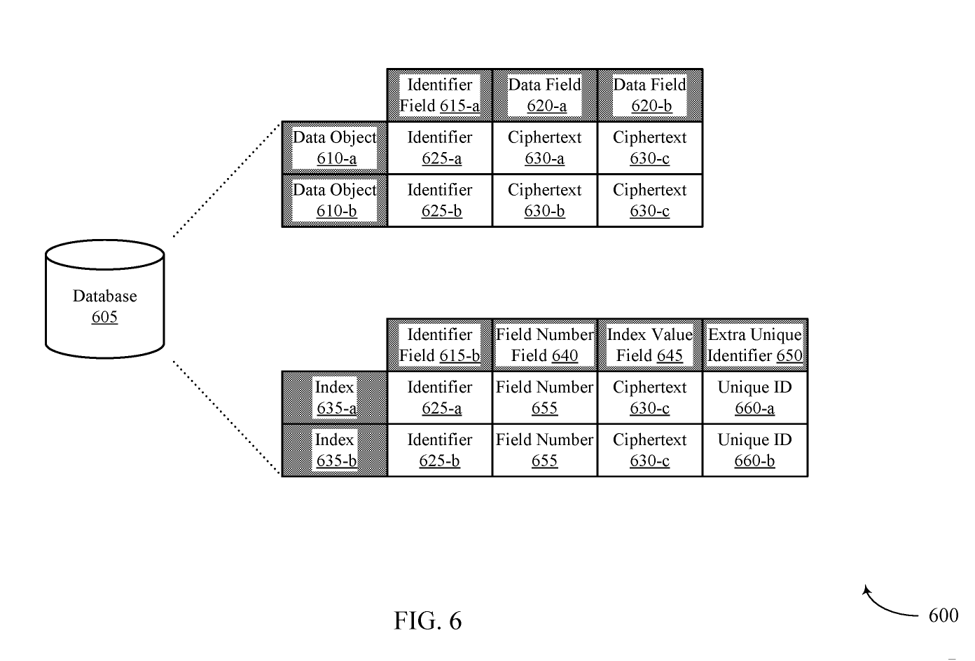

FIG. 6 illustrates an example of a database storage system 600 that supports filtering and unicity with deterministic encryption in accordance with various aspects of the present disclosure. Database storage system 600 may include a database 605, which may be an example of a data center 120 or a database 270, 340, 440, or 525 as discussed with respect to FIGS. 1 through 5. Database storage system 600 may support unicity handling for deterministic encryption.

Database 605 may store data objects 610 in a standard field table or a custom field table. For example, database 605 may store data objects 610-a and 610-b. Each data object 610 may be identified based on one or more identifier fields 615, such as identifier field 615-a. Data object 610-a may be identified based on identifier 625-a, and data object 610-b may be identified based on identifier 625-b. Identifiers 625 may be examples of tenant identifiers, organization identifiers, data type identifiers, external identifiers, or any other identifier differentiating between the data objects 610 stored in database 605. Each data object 610 may additionally have one or more associated data fields 620. For example, data objects 610-a and 610-b may include data fields 620-a and 620-b, which may contain encrypted or unencrypted data. In one example, data object 610-a may store ciphertext 630-a for data field 620-a, and ciphertext 630-c for data field 620-b. Meanwhile, data object 610-b may store ciphertext 630-b for data field 620-a, and ciphertext 630-c for data field 620-b.

In some cases, a user may assign a data field 620 as a unique data field. For example, a user may apply a unicity requirement to data field 620-b. In such an example, data field 620-b may not support containing the same data for multiple data objects 610. However, in some scenarios, data field 620-b may store ciphertexts 630 associated with a same plaintext. For example, during a key rotation process, database 605 may store a first data object 610-a with a ciphertext 630 encrypted using a first encryption key in data field 620-b, and a second data object 610-b with a different ciphertext 630 encrypted using a second encryption key also in data field 620-b. However, due to the different encryption keys, the two different ciphertexts 630 may correspond to the same plaintext value. Database 605 may not recognize that the different cipheretexts 630 correspond to a non-unique plaintext value, and may store both in data field 620-b. As the data in data field 620-b is re-encrypted in the key rotation process, both data objects 610-a and 610-b may be encrypted using a same encryption key, which may result in each having a same ciphertext 630-c stored for data field 620-b, which may fail the unicity requirement.

In such cases, to avoid the system breaking due to the failed unicity requirement, database 605 may introduce unique identifers 660 to differentiate the ciphertexts 630-c. In some cases, the unique identifiers 660 may be stored in an additional data field 620 for the data objects 610. In other cases, the unique identifiers 660 may be stored in a custom index table. The custom index table may include indexes 635 corresponding to one or more data objects 610. Each index 635 may include an indentifier field 615-b, which may associate the index 635 with a data object 610. For example, index 635-a includes identifier 625-a, which may correspond to the identifer 625-a stored in identifier field 615-a for data object 610-a. Similarly, index 635-b may be associated with data object 610-b based on identifier 625-b.

Each index 635 may additionally include a field number field 640, which may correspond to a specific data field 620 of the associated data object 610. For example, indexes 635-a and 635-b may both include field number 655, which may correspond to data field 620-b. In some cases, the indexes 635 may additionally include index value field 645, which may contain the data stored in the corresponding data field 620 (e.g., non-unique ciphertexts 630-c). The indexes 635 may additionally include extra unique identifier field 650, which may contain unique identifiers 660. For example, index 635-a may include unique identifier 660-a, while index 635-b may include unique identifier 660-b. In some cases, database 605 may automatically generate unique identifiers 660 (e.g., randomly generated identifiers) for encrypted unique data fields 620. In other cases, database 605 may identify non-unique data during an encryption process, and may store the unique identifiers 660 based on identifying the non-unique data. Database 605 may apply the unicity requirement on a combination of the index value field 645 and the extra unique identifier 650. In this way, non-unique ciphertexts 630-c may not break the unicity requirement, as the combination of ciphertext 630-c with unique identifier 660-a is different than the combination of ciphertext 630-c with unique identifier 660-b. In this way, database 605 may handle unicity on deterministically encrypted data fields.

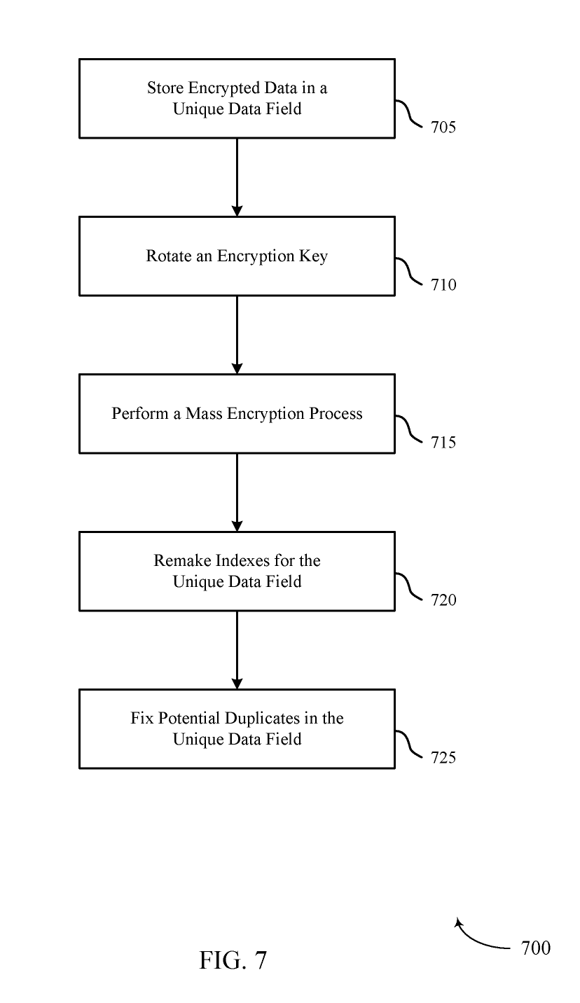

FIG. 7 illustrates an example of a process flow 700 that supports filtering and unicity with deterministic encryption in accordance with various aspects of the present disclosure. Process flow 700 may be performed by an application cloud, a database, or a combination of the two. These may be examples of the corresponding devices, as described with reference to FIGS. 1 through 6. Process flow 700 may illustrate a key rotation process to handle unicity for deterministically encrypted data.

At 705, a database may store encrypted data in a data field specified for unicity. The data may be encrypted based on a first deterministic encryption key, or on a set of encryption keys (e.g., an active encryption key and an archived encryption key).

At 710, the database may rotate the encryption key used to encrypt the data. For example, a key derivation server may generate a new active encryption key. The database may identify any data encrypted using an archived encryption key.

At 715, the database or application cloud may perform a mass encryption process. The database or application cloud may decrypt the identified data, and may re-encrypt the data using the new active encryption key. In this way, the database may destroy an archived key, while maintaining the security of the data and access to the data. At the end of the key rotation and mass encryption process, all of the data stored in the data field specified for unicity may be encrypted using a same active encryption key.

At 720, the database may remake indexes for the data. For example, the database may identify any data that may not pass the unicity requirement, and may generate a unique identifier for the identified data to satisfy the unicity requirement. In some cases, 720 may be performed througout the mass encryption process.

At 725, the database may fix potential duplicates. For example, any data that uses a unique identifier to satisfy the unicity requirement may be identified as duplicates. In some cases, the database may delete one or more values from the data field in order to meet the unicity requirement. In other cases, the database may perform an aggregation process on non-unique data to meet the unicity requirement. In yet other cases, the database may send an indication of the potential duplicates to a user device, and a user may select what processes to perform to fix the potential duplicates.

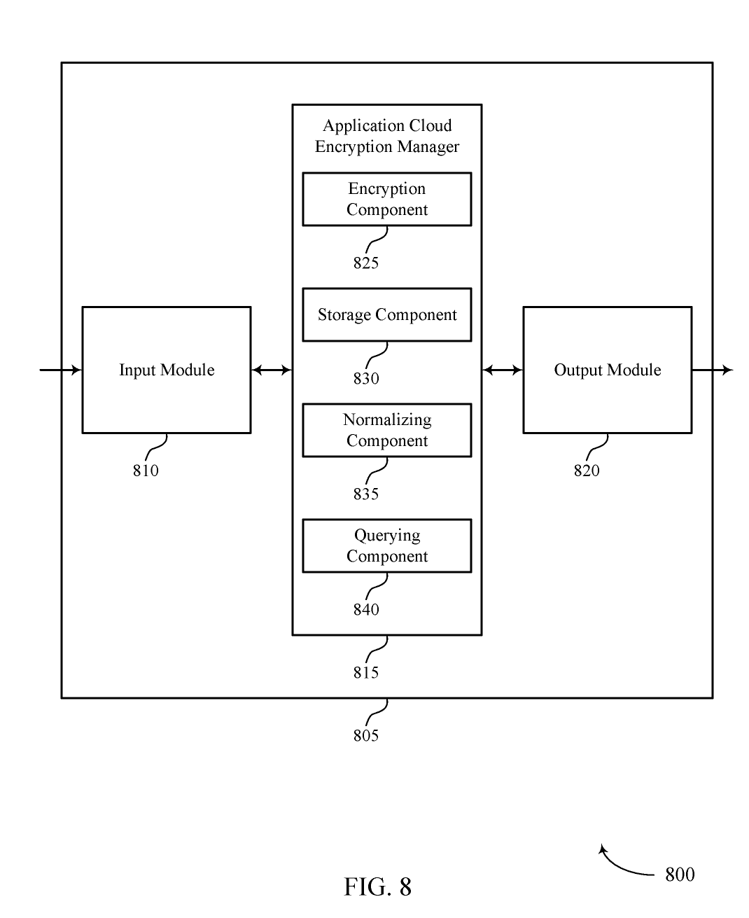

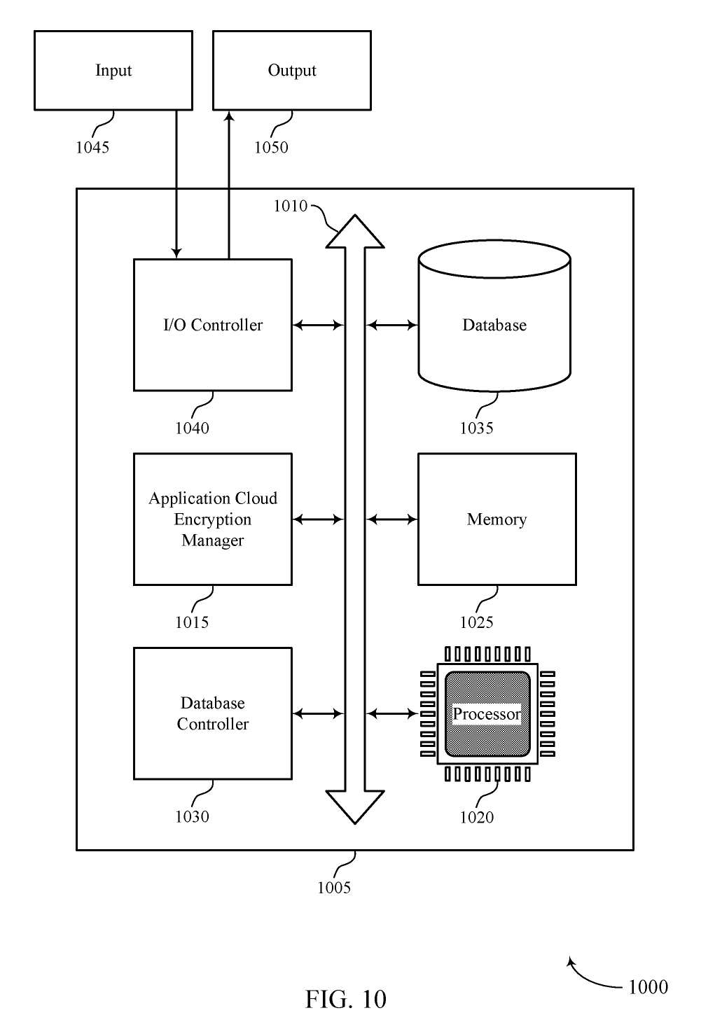

FIG. 8 shows a block diagram 800 of an apparatus 805 that supports filtering and unicity with deterministic encryption in accordance with aspects of the present disclosure. Apparatus 805 may include input module 810, application cloud encryption manager 815, and output module 820. Apparatus 805 may also include a processor. Each of these components may be in communication with one another (e.g., via one or more buses). In some cases, apparatus 805 may be an example of a user terminal, a database server, or a system containing multiple computing devices. Application cloud encryption manager 815 may be an example of aspects of the application cloud encryption manager 1015 described with reference to FIG. 10. Application cloud encryption manager 815 may also include encryption component 825, storage component 830, normalizing component 835, and querying component 840.

Application cloud encryption manager 815 and/or at least some of its various sub-components may be implemented in hardware, software executed by a processor, firmware, or any combination thereof. If implemented in software executed by a processor, the functions of the application cloud encryption manager 815 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The application cloud encryption manager 815 and/or at least some of its various sub-components may be physically located at various positions, including being distributed such that portions of functions are implemented at different physical locations by one or more physical devices. In some examples, application cloud encryption manager 815 and/or at least some of its various sub-components may be a separate and distinct component in accordance with various aspects of the present disclosure. In other examples, application cloud encryption manager 815 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Encryption component 825 may encrypt a plaintext value based on an encryption function, where the plaintext value includes uppercase characters and lowercase characters. In some cases, the encryption function is a deterministic encryption function.

Storage component 830 may send a first ciphertext associated with the encrypted plaintext value to a database, send a second ciphertext associated with the encrypted normalized version of the plaintext value to the database, and send a third ciphertext associated with the encrypted normalized version of the plaintext value to the database.

Normalizing component 835 may encrypt a normalized version of the plaintext value based on the encryption function, where the normalized version of the plaintext value consists of lowercase characters. In some cases, encrypting the normalized version of the plaintext value is based on a first encryption key. Normalizing component 835 may encrypt a second normalized version of the plaintext value based on the encryption function and a second encryption key. Querying component 840 may query the database for the plaintext value based on the second ciphertext.

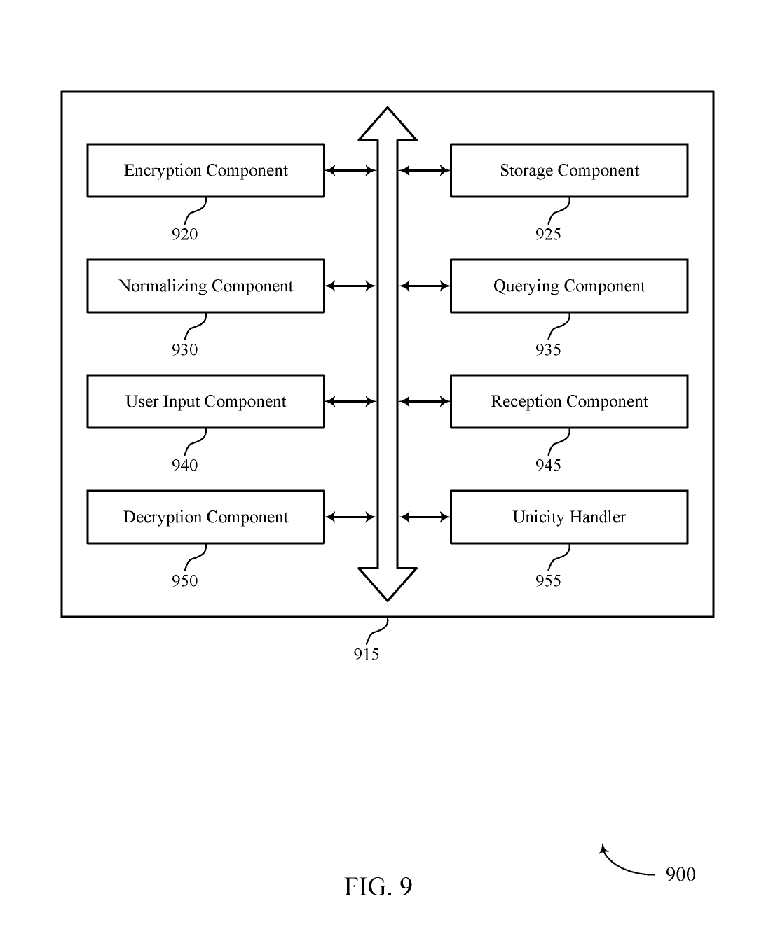

FIG. 9 shows a block diagram 900 of an application cloud encryption manager 915 that supports filtering and unicity with deterministic encryption in accordance with aspects of the present disclosure. The application cloud encryption manager 915 may be an example of aspects of an application cloud encryption manager 815 or 1015 described with reference to FIGS. 8 and 10. The application cloud encryption manager 915 may include encryption component 920, storage component 925, normalizing component 930, querying component 935, user input component 940, reception component 945, decryption component 950, and unicity handler 955. Each of these modules may communicate, directly or indirectly, with one another (e.g., via one or more buses).

Encryption component 920 may encrypt a plaintext value based on an encryption function, where the plaintext value includes uppercase characters and lowercase characters. In some cases, the encryption function is a deterministic encryption function.

Storage component 925 may send a first ciphertext associated with the encrypted plaintext value to a database, send a second ciphertext associated with the encrypted normalized version of the plaintext value to the database, and send a third ciphertext associated with the encrypted normalized version of the plaintext value to the database.

Normalizing component 930 may encrypt a normalized version of the plaintext value based on the encryption function, where the normalized version of the plaintext value consists of lowercase characters. In some cases, the encrypting the normalized version of the plaintext value is based on a first encryption key, the method further including encrypting a second normalized version of the plaintext value based on the encryption function and a second encryption key. Querying component 935 may query the database for the plaintext value based on the second ciphertext. In some cases, querying component 935 may query the database for the plaintext value based on the third plaintext.

User input component 940 may receive, from a user, a query message indicating the plaintext value, where querying the database includes identifying the second ciphertext based on the plaintext value and the encryption function. User input component 940 may further receive, from a user, a request to apply a case insensitive unicity requirement to a first data field of the database associated with the first ciphertext.

Reception component 945 may receive, from the database, the first ciphertext based on querying the database. Decryption component 950 may decrypt the first ciphertext based on the encryption function.

Unicity handler 955 may modify the request, where the modified request applies the case insensitive unicity requirement to a second data field of the database associated with the second ciphertext, and may send the case insensitive unicity requirement to the database.

FIG. 10 shows a diagram of a system 1000 including a subsystem 1005 that supports filtering and unicity with deterministic encryption in accordance with aspects of the present disclosure. Subsystem 1005 may be an example of or include the components of a cloud platform 115 or an application cloud 220, 320, 420, or 520 as described above, e.g., with reference to FIGS. 1 through 5. Subsystem 1005 may include components for bi-directional data communications including components for transmitting and receiving communications, including application cloud encryption manager 1015, processor 1020, memory 1025, database controller 1030, database 1035, and I/O controller 1040. These components may be in electronic communication via one or more buses (e.g., bus 1010).

Processor 1020 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1020 may be configured to operate a memory array using a memory controller. In other cases, a memory controller may be integrated into processor 1020. Processor 1020 may be configured to execute computer-readable instructions stored in a memory to perform various functions (e.g., functions or tasks supporting filtering and unicity for deterministic encryption).

Memory 1025 may include random access memory (RAM) and read only memory (ROM). The memory 1025 may store computer-readable, computer-executable software 1030 including instructions that, when executed, cause the processor to perform various functions described herein. In some cases, the memory 1025 may contain, among other things, a basic input/output system (BIOS) which may control basic hardware or software operation such as the interaction with peripheral components or devices.

Database controller 1030 may manage data storage and processing in database 1035. In some cases, a user may interact with database controller 1030. In other cases, database controller 1030 may operate automatically without user interaction. Database 1035 may be an example of a single database, a distributed database, multiple distributed databases, or an emergency backup database.

I/O controller 1040 may manage input and output signals for device 1005. I/O controller 1040 may also manage peripherals not integrated into device 1005. In some cases, I/O controller 1040 may represent a physical connection or port to an external peripheral. In some cases, I/O controller 1040 may utilize an operating system such as iOS®, ANDROID®, MS-DOS®, MS-WINDOWS®, OS/2®, UNIX®, LINUX®, or another known operating system. In other cases, I/O controller 1040 may represent or interact with a modem, a keyboard, a mouse, a touchscreen, or a similar device. In some cases, I/O controller 1040 may be implemented as part of a processor. In some cases, a user may interact with device 1005 via I/O controller 1040 or via hardware components controlled by I/O controller 1040.

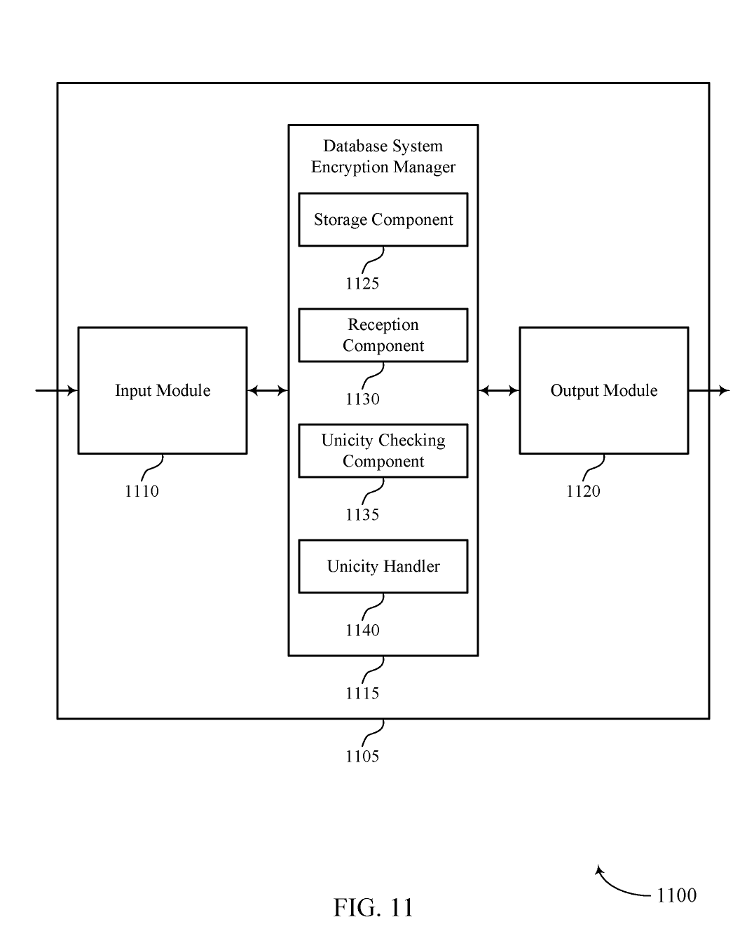

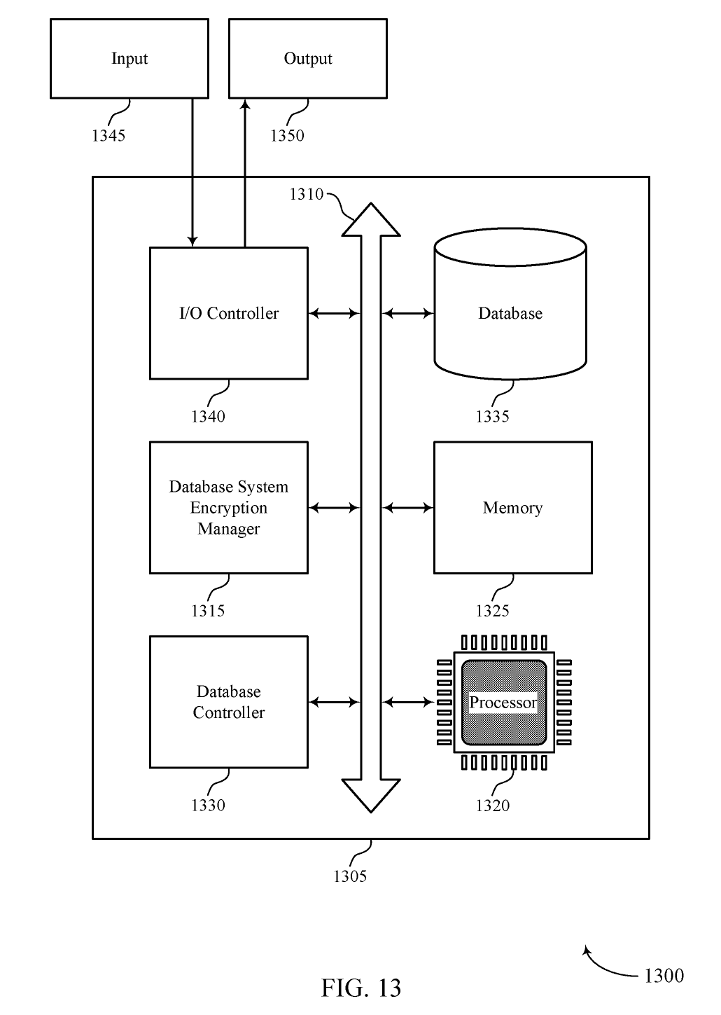

FIG. 11 shows a block diagram 1100 of an apparatus 1105 that supports filtering and unicity with deterministic encryption in accordance with aspects of the present disclosure. Apparatus 1105 may include input module 1110, database system encryption manager 1115, and output module 1120. Apparatus 1105 may also include a processor. Each of these components may be in communication with one another (e.g., via one or more buses). In some cases, apparatus 1105 may be an example of a user terminal, a database server, or a system containing multiple computing devices. Database system encryption manager 1115 may be an example of aspects of the database system encryption manager 1315 described with reference to FIG. 13. Database system encryption manager 1115 may also include storage component 1125, reception component 1130, unicity checking component 1135, and unicity handler 1140.

Database system encryption manager 1115 and/or at least some of its various sub-components may be implemented in hardware, software executed by a processor, firmware, or any combination thereof. If implemented in software executed by a processor, the functions of the database system encryption manager 1115 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The database system encryption manager 1115 and/or at least some of its various sub-components may be physically located at various positions, including being distributed such that portions of functions are implemented at different physical locations by one or more physical devices. In some examples, database system encryption manager 1115 and/or at least some of its various sub-components may be a separate and distinct component in accordance with various aspects of the present disclosure. In other examples, database system encryption manager 1115 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Storage component 1125 may store, in a first data field, a first ciphertext associated with a first plaintext value. Reception component 1130 may receive a second ciphertext associated with a second plaintext value, where the first ciphertext and the second ciphertext are encrypted using a deterministic encryption function. Storage component 1125 may store, in the first data field, the second ciphertext.

Unicity checking component 1135 may identify that the first ciphertext and the second ciphertext are the same. Unicity handler 1140 may store, in a second data field, a first unique identifier for the first ciphertext and a second unique identifier for the second ciphertext, where the first unique identifier and the second unique identifier distinguish between the first ciphertext and the second ciphertext. In some cases, the first data field is subject to a unicity requirement, and the unicity checking component 1135 may apply the unicity requirement to a combination of the first data field and the second data field. In some cases, the first data field includes a case insensitive unicity requirement. Unicity checking component 1135 may store, in a third data field, a fourth ciphertext associated with a normalized version of the first plaintext value, where the normalized version of the first plaintext value consists of lowercase characters.

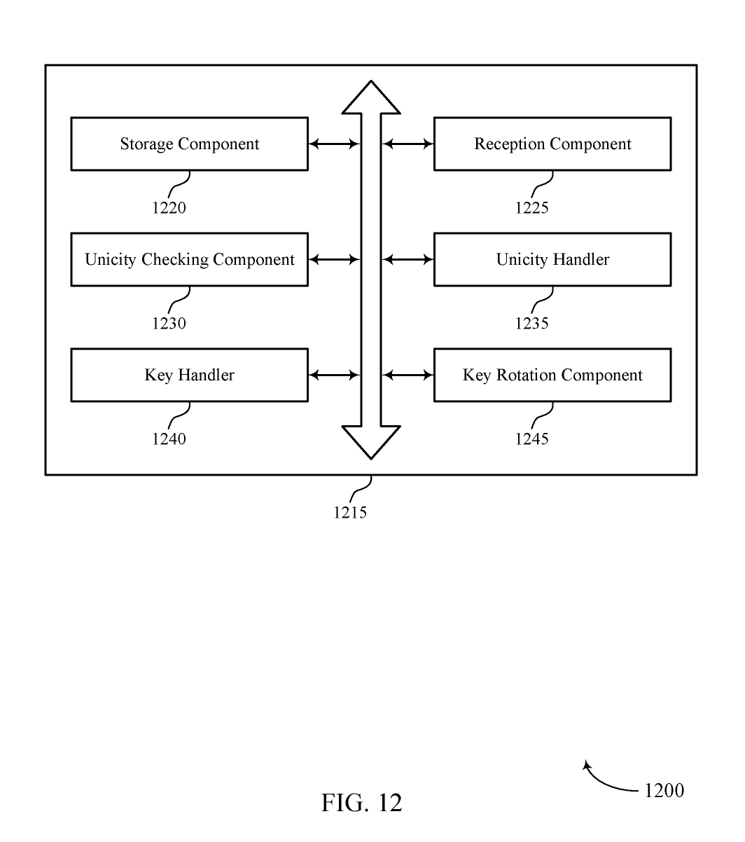

FIG. 12 shows a block diagram 1200 of a database system encryption manager 1215 that supports filtering and unicity with deterministic encryption in accordance with aspects of the present disclosure. The database system encryption manager 1215 may be an example of aspects of a database system encryption manager 1315 described with reference to FIGS. 11 and 13. The database system encryption manager 1215 may include storage component 1220, reception component 1225, unicity checking component 1230, unicity handler 1235, key handler 1240, and key rotation component 1245. Each of these modules may communicate, directly or indirectly, with one another (e.g., via one or more buses).

Storage component 1220 may store, in a first data field, a first ciphertext associated with a first plaintext value and may store, in the first data field, a second ciphertext. Reception component 1225 may receive the second ciphertext associated with a second plaintext value, where the first ciphertext and the second ciphertext are encrypted using a deterministic encryption function.

Unicity checking component 1230 may identify that the first ciphertext and the second ciphertext are the same. Unicity handler 1235 may store, in a second data field, a first unique identifier for the first ciphertext and a second unique identifier for the second ciphertext, where the first unique identifier and the second unique identifier distinguish between the first ciphertext and the second ciphertext. In some cases, the first data field is subject to a unicity requirement, and unicity checking component 1230 may apply the unicity requirement to a combination of the first data field and the second data field. In some cases, the first data field includes a case insensitive unicity requirement, and unicity checking component 1230 may store, in a third data field, a fourth ciphertext associated with a normalized version of the first plaintext value, where the normalized version of the first plaintext value consists of lowercase characters. Unicity checking component 1230 may apply the case insensitive unicity requirement to the third data field.

Key handler 1240 may identify that the first ciphertext is associated with a first encryption key and the second ciphertext is associated with a second encryption key. Key rotation component 1245 may store, in the first data field, a third ciphertext associated with the first plaintext value and the second encryption key, where the third ciphertext and the second ciphertext are different. Key rotation component 1245 may then remove, from the first data field, the first ciphertext.

FIG. 13 shows a diagram of a system 1300 including a subsystem 1305 that supports filtering and unicity with deterministic encryption in accordance with aspects of the present disclosure. Subsystem 1305 may be an example of or include the components of a data center 120 or a database 270, 340, 440, 525, or 605 as described above, e.g., with reference to FIGS. 1 through 6. Subsystem 1305 may include components for bi-directional data communications including components for transmitting and receiving communications, including database system encryption manager 1315, processor 1320, memory 1325, database controller 1330, database 1335, and I/O controller 1340. These components may be in electronic communication via one or more buses (e.g., bus 1310).

Processor 1320 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1320 may be configured to operate a memory array using a memory controller. In other cases, a memory controller may be integrated into processor 1320. Processor 1320 may be configured to execute computer-readable instructions stored in a memory to perform various functions (e.g., functions or tasks supporting filtering and unicity for deterministic encryption).

Memory 1325 may include RAM and ROM. The memory 1325 may store computer-readable, computer-executable software 1330 including instructions that, when executed, cause the processor to perform various functions described herein. In some cases, the memory 1325 may contain, among other things, a BIOS which may control basic hardware or software operation such as the interaction with peripheral components or devices.

Database controller 1330 may manage data storage and processing in database 1335. In some cases, a user may interact with database controller 1330. In other cases, database controller 1330 may operate automatically without user interaction. Database 1335 may be an example of a single database, a distributed database, multiple distributed databases, or an emergency backup database.

I/O controller 1340 may manage input and output signals for device 1305. I/O controller 1340 may also manage peripherals not integrated into device 1305. In some cases, I/O controller 1340 may represent a physical connection or port to an external peripheral. In some cases, I/O controller 1340 may utilize an operating system such as iOS®, ANDROID®, MS-DOS®, MS-WINDOWS®, OS/2®, UNIX®, LINUX®, or another known operating system. In other cases, I/O controller 1340 may represent or interact with a modem, a keyboard, a mouse, a touchscreen, or a similar device. In some cases, I/O controller 1340 may be implemented as part of a processor. In some cases, a user may interact with device 1305 via I/O controller 1340 or via hardware components controlled by I/O controller 1340.

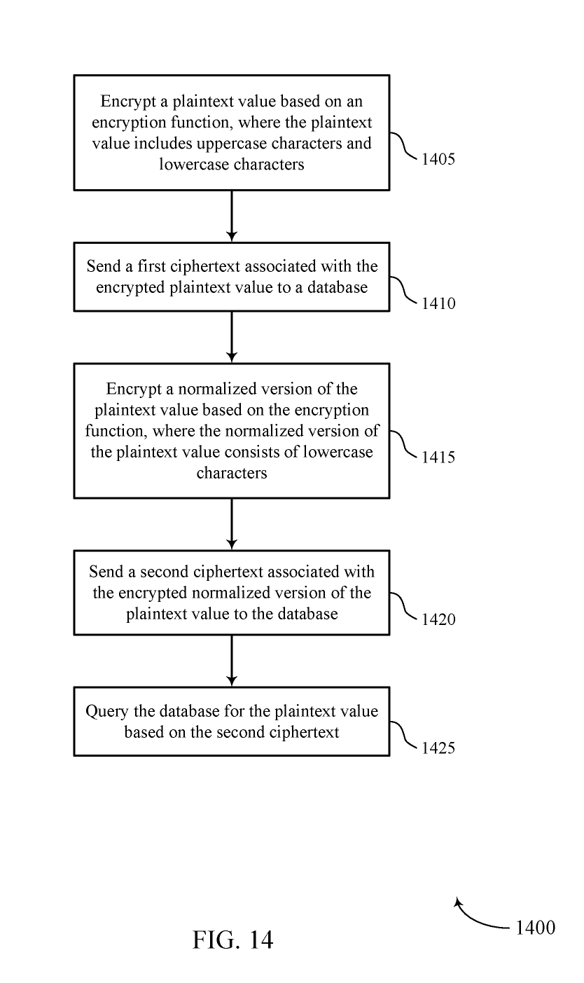

FIG. 14 shows a flowchart illustrating a method 1400 for filtering and unicity with deterministic encryption in accordance with aspects of the present disclosure. The operations of method 1400 may be implemented by an application cloud 220, 320, 420, or 520 or its components as described herein. For example, the operations of method 1400 may be performed by an application cloud encryption manager as described with reference to FIGS. 8 through 10. In some examples, an application cloud 220, 320, 420, or 520 may execute a set of codes to control the functional elements of the device to perform the functions described below. Additionally or alternatively, the application cloud may perform aspects of the functions described below using special-purpose hardware.

At block 1405 the application cloud may encrypt a plaintext value based at least in part on an encryption function, wherein the plaintext value comprises uppercase characters and lowercase characters. The operations of block 1405 may be performed according to the methods described herein. In certain examples, aspects of the operations of block 1405 may be performed by an encryption component as described with reference to FIGS. 8 through 10.

At block 1410 the application cloud may send a first ciphertext associated with the encrypted plaintext value to a database. The operations of block 1410 may be performed according to the methods described herein. In certain examples, aspects of the operations of block 1410 may be performed by a storage component as described with reference to FIGS. 8 through 10.

At block 1415 the application cloud may encrypt a normalized version of the plaintext value based at least in part on the encryption function, wherein the normalized version of the plaintext value consists of lowercase characters. The operations of block 1415 may be performed according to the methods described herein. In certain examples, aspects of the operations of block 1415 may be performed by a normalizing component as described with reference to FIGS. 8 through 10.

At block 1420 the application cloud may send a second ciphertext associated with the encrypted normalized version of the plaintext value to the database. The operations of block 1420 may be performed according to the methods described herein. In certain examples, aspects of the operations of block 1420 may be performed by a storage component as described with reference to FIGS. 8 through 10.

At block 1425 the application cloud may query the database for the plaintext value based at least in part on the second ciphertext. The operations of block 1425 may be performed according to the methods described herein. In certain examples, aspects of the operations of block 1425 may be performed by a querying component as described with reference to FIGS. 8 through 10.

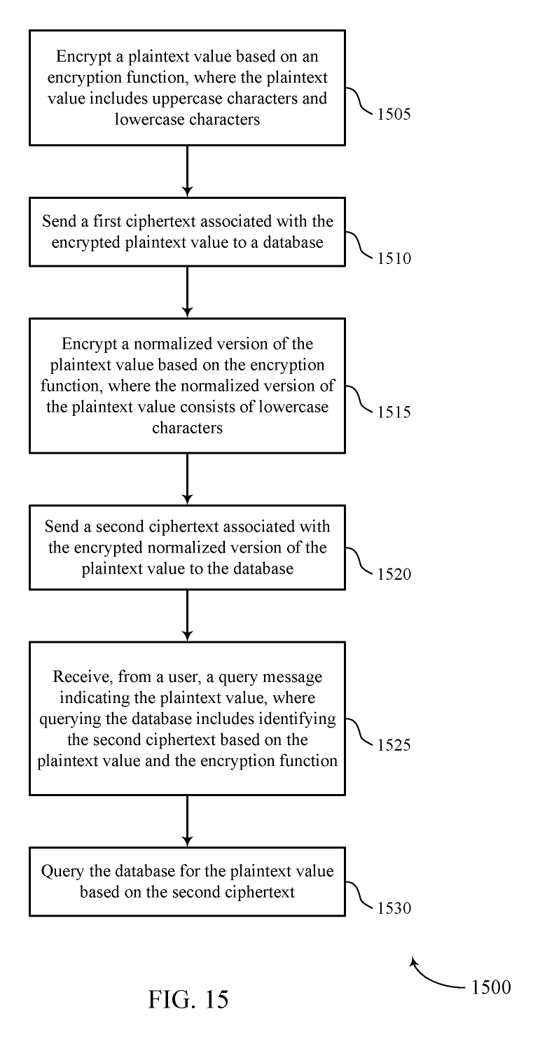

FIG. 15 shows a flowchart illustrating a method 1500 for filtering and unicity with deterministic encryption in accordance with aspects of the present disclosure. The operations of method 1500 may be implemented by an application cloud 220, 320, 420, or 520 or its components as described herein. For example, the operations of method 1500 may be performed by an application cloud encryption manager as described with reference to FIGS. 8 through 10. In some examples, an application cloud 220, 320, 420, or 520 may execute a set of codes to control the functional elements of the device to perform the functions described below. Additionally or alternatively, the application cloud may perform aspects of the functions described below using special-purpose hardware.

At block 1505 the application cloud may encrypt a plaintext value based at least in part on an encryption function, wherein the plaintext value comprises uppercase characters and lowercase characters. The operations of block 1505 may be performed according to the methods described herein. In certain examples, aspects of the operations of block 1505 may be performed by an encryption component as described with reference to FIGS. 8 through 10.

At block 1510 the application cloud may send a first ciphertext associated with the encrypted plaintext value to a database. The operations of block 1510 may be performed according to the methods described herein. In certain examples, aspects of the operations of block 1510 may be performed by a storage component as described with reference to FIGS. 8 through 10.

At block 1515 the application cloud may encrypt a normalized version of the plaintext value based at least in part on the encryption function, wherein the normalized version of the plaintext value consists of lowercase characters. The operations of block 1515 may be performed according to the methods described herein. In certain examples, aspects of the operations of block 1515 may be performed by a normalizing component as described with reference to FIGS. 8 through 10.

At block 1520 the application cloud may send a second ciphertext associated with the encrypted normalized version of the plaintext value to the database. The operations of block 1520 may be performed according to the methods described herein. In certain examples, aspects of the operations of block 1520 may be performed by a storage component as described with reference to FIGS. 8 through 10.

At block 1525 the application cloud may receive, from a user, a query message indicating the plaintext value, wherein querying the database comprises identifying the second ciphertext based at least in part on the plaintext value and the encryption function. The operations of block 1525 may be performed according to the methods described herein. In certain examples, aspects of the operations of block 1525 may be performed by a user input component as described with reference to FIGS. 8 through 10.

At block 1530 the application cloud may query the database for the plaintext value based at least in part on the second ciphertext. The operations of block 1530 may be performed according to the methods described herein. In certain examples, aspects of the operations of block 1530 may be performed by a querying component as described with reference to FIGS. 8 through 10.

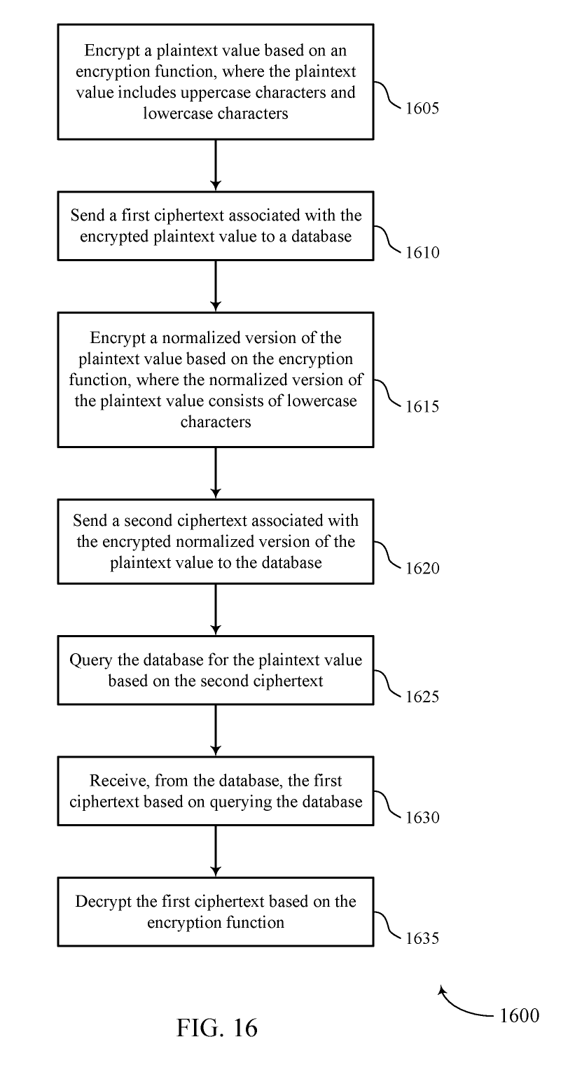

FIG. 16 shows a flowchart illustrating a method 1600 for filtering and unicity with deterministic encryption in accordance with aspects of the present disclosure. The operations of method 1600 may be implemented by an application cloud 220, 320, 420, or 520 or its components as described herein. For example, the operations of method 1600 may be performed by an application cloud encryption manager as described with reference to FIGS. 8 through 10. In some examples, an application cloud 220, 320, 420, or 520 may execute a set of codes to control the functional elements of the device to perform the functions described below. Additionally or alternatively, the application cloud may perform aspects of the functions described below using special-purpose hardware.

At block 1605 the application cloud may encrypt a plaintext value based at least in part on an encryption function, wherein the plaintext value comprises uppercase characters and lowercase characters. The operations of block 1605 may be performed according to the methods described herein. In certain examples, aspects of the operations of block 1605 may be performed by an encryption component as described with reference to FIGS. 8 through 10.

At block 1610 the application cloud may send a first ciphertext associated with the encrypted plaintext value to a database. The operations of block 1610 may be performed according to the methods described herein. In certain examples, aspects of the operations of block 1610 may be performed by a storage component as described with reference to FIGS. 8 through 10.

At block 1615 the application cloud may encrypt a normalized version of the plaintext value based at least in part on the encryption function, wherein the normalized version of the plaintext value consists of lowercase characters. The operations of block 1615 may be performed according to the methods described herein. In certain examples, aspects of the operations of block 1615 may be performed by a normalizing component as described with reference to FIGS. 8 through 10.

At block 1620 the application cloud may send a second ciphertext associated with the encrypted normalized version of the plaintext value to the database. The operations of block 1620 may be performed according to the methods described herein. In certain examples, aspects of the operations of block 1620 may be performed by a storage component as described with reference to FIGS. 8 through 10.

At block 1625 the application cloud may query the database for the plaintext value based at least in part on the second ciphertext. The operations of block 1625 may be performed according to the methods described herein. In certain examples, aspects of the operations of block 1625 may be performed by a querying component as described with reference to FIGS. 8 through 10.

At block 1630 the application cloud may receive, from the database, the first ciphertext based at least in part on querying the database. The operations of block 1630 may be performed according to the methods described herein. In certain examples, aspects of the operations of block 1630 may be performed by a reception component as described with reference to FIGS. 8 through 10.

At block 1635 the application cloud may decrypt the first ciphertext based at least in part on the encryption function. The operations of block 1635 may be performed according to the methods described herein. In certain examples, aspects of the operations of block 1635 may be performed by a decryption component as described with reference to FIGS. 8 through 10.

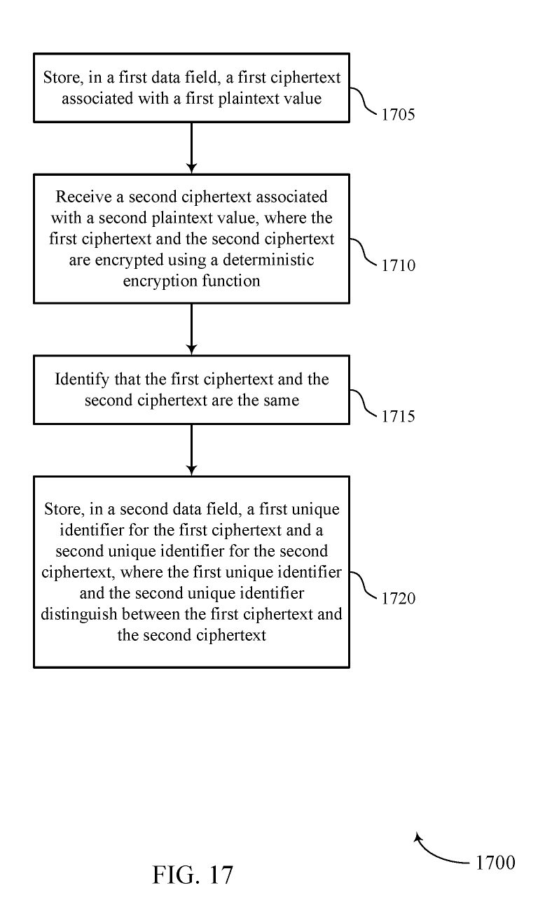

FIG. 17 shows a flowchart illustrating a method 1700 for filtering and unicity with deterministic encryption in accordance with aspects of the present disclosure. The operations of method 1700 may be implemented by a database system, such as a database 270, 340, 440, 525, or 605 or its components as described herein. For example, the operations of method 1700 may be performed by a database system encryption manager as described with reference to FIGS. 11 through 13. In some examples, a database system (e.g., a database 270, 340, 440, 525, or 605) may execute a set of codes to control the functional elements of the device to perform the functions described below. Additionally or alternatively, the database system may perform aspects of the functions described below using special-purpose hardware.

At block 1705 the database system may store, in a first data field, a first ciphertext associated with a first plaintext value. The operations of block 1705 may be performed according to the methods described herein. In certain examples, aspects of the operations of block 1705 may be performed by a storage component as described with reference to FIGS. 11 through 13.

At block 1710 the database system may receive a second ciphertext associated with a second plaintext value, wherein the first ciphertext and the second ciphertext are encrypted using a deterministic encryption function. The operations of block 1710 may be performed according to the methods described herein. In certain examples, aspects of the operations of block 1710 may be performed by a reception component as described with reference to FIGS. 11 through 13.

At block 1715 the database system may identify that the first ciphertext and the second ciphertext are the same. The operations of block 1715 may be performed according to the methods described herein. In certain examples, aspects of the operations of block 1715 may be performed by a unicity checking component as described with reference to FIGS. 11 through 13.

At block 1720 the database system may store, in a second data field, a first unique identifier for the first ciphertext and a second unique identifier for the second ciphertext, wherein the first unique identifier and the second unique identifier distinguish between the first ciphertext and the second ciphertext. The operations of block 1720 may be performed according to the methods described herein. In certain examples, aspects of the operations of block 1720 may be performed by a unicity handler as described with reference to FIGS. 11 through 13.

A method of deterministic encryption is described. The method may include encrypting a plaintext value based at least in part on an encryption function, wherein the plaintext value comprises uppercase characters and lowercase characters, and sending a first ciphertext associated with the encrypted plaintext value to a database. The method may further include encrypting a normalized version of the plaintext value based at least in part on the encryption function, wherein the normalized version of the plaintext value consists of lowercase characters, sending a second ciphertext associated with the encrypted normalized version of the plaintext value to the database, and querying the database for the plaintext value based at least in part on the second ciphertext.

An apparatus for deterministic encryption is described. The apparatus may include a processor, memory in electronic communication with the processor, and instructions stored in the memory. The instructions may be operable to cause the processor to encrypt a plaintext value based at least in part on an encryption function, wherein the plaintext value comprises uppercase characters and lowercase characters, and send a first ciphertext associated with the encrypted plaintext value to a database. The instructions may be further operable to encrypt a normalized version of the plaintext value based at least in part on the encryption function, wherein the normalized version of the plaintext value consists of lowercase characters, send a second ciphertext associated with the encrypted normalized version of the plaintext value to the database, and query the database for the plaintext value based at least in part on the second ciphertext.

Some examples of the method and apparatus described above may further include processes, features, means, or instructions for receiving, from a user, a query message indicating the plaintext value, wherein querying the database comprises identifying the second ciphertext based at least in part on the plaintext value and the encryption function.

Some examples of the method and apparatus described above may further include processes, features, means, or instructions for receiving, from the database, the first ciphertext based at least in part on querying the database. Some examples of the method and apparatus described above may further include processes, features, means, or instructions for decrypting the first ciphertext based at least in part on the encryption function.

In some examples of the method and apparatus described above, encrypting the normalized version of the plaintext value may be based at least in part on a first encryption key, the method further comprising encrypting a second normalized version of the plaintext value based at least in part on the encryption function and a second encryption key. Some examples of the method and apparatus described above may further include processes, features, means, or instructions for sending a third ciphertext associated with the encrypted normalized version of the plaintext value to the database, and querying the database for the plaintext value based at least in part on the third ciphertext.

Some examples of the method and apparatus described above may further include processes, features, means, or instructions for receiving, from a user, a request to apply a case insensitive unicity requirement to a first data field of the database associated with the first ciphertext. Some examples of the method and apparatus described above may further include processes, features, means, or instructions for modifying the request, wherein the modified request applies the case insensitive unicity requirement to indicate a second data field of the database associated with the second ciphertext. Some examples of the method and apparatus described above may further include processes, features, means, or instructions for sending the case insensitive unicity requirement to the database. In some examples of the method and apparatus described above, the encryption function may be a deterministic encryption function.

Another method of deterministic encryption is described. The method may include storing, in a first data field, a first ciphertext associated with a first plaintext value, and receiving a second ciphertext associated with a second plaintext value, wherein the first ciphertext and the second ciphertext are encrypted using a deterministic encryption function. The method may further include identifying that the first ciphertext and the second ciphertext are the same, and storing, in a second data field, a first unique identifier for the first ciphertext and a second unique identifier for the second ciphertext, wherein the first unique identifier and the second unique identifier distinguish between the first ciphertext and the second ciphertext.

Another apparatus for deterministic encryption is described. The apparatus may include a processor, memory in electronic communication with the processor, and instructions stored in the memory. The instructions may be operable to cause the processor to store, in a first data field, a first ciphertext associated with a first plaintext value, receive a second ciphertext associated with a second plaintext value, wherein the first ciphertext and the second ciphertext are encrypted using a deterministic encryption function, and identify that the first ciphertext and the second ciphertext are the same. The instructions may further be operable to store, in a second data field, a first unique identifier for the first ciphertext and a second unique identifier for the second ciphertext, wherein the first unique identifier and the second unique identifier distinguish between the first ciphertext and the second ciphertext.

Some examples of the method and apparatus described above may further include processes, features, means, or instructions for storing, in the first data field, the second ciphertext. In some examples of the method and apparatus described above, the first ciphertext may be associated with a first encryption key and the second ciphertext may be associated with a second encryption key.

Some examples of the method and apparatus described above may further include processes, features, means, or instructions for storing, in the first data field, a third ciphertext associated with the first plaintext value and the second encryption key, wherein the third ciphertext and the second ciphertext may be different. Some examples of the method and apparatus described above may further include processes, features, means, or instructions for removing, from the first data field, the first ciphertext.

In some examples of the method and apparatus described above, the first data field may be subject to a unicity requirement, the method further comprising applying the unicity requirement to a combination of the first data field and the second data field.

In some examples of the method and apparatus described above, the first data field comprises a case insensitive unicity requirement, the method further comprising storing, in a third data field, a fourth ciphertext associated with a normalized version of the first plaintext value, wherein the normalized version of the first plaintext value consists of lowercase characters. Some examples of the method and apparatus described above may further include processes, features, means, or instructions for applying the case insensitive unicity requirement to the third data field.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for deterministic encryption, comprising:
encrypting a plaintext value based at least in part on an encryption function, wherein the plaintext value comprises uppercase characters and lowercase characters;
sending a first ciphertext associated with the encrypted plaintext value to a database;
encrypting a normalized version of the plaintext value based at least in part on the encryption function, wherein the normalized version of the plaintext value consists of lowercase characters;
sending a second ciphertext associated with the encrypted normalized version of the plaintext value to the database; and
querying the database for the plaintext value based at least in part on the second ciphertext.

2. The method of claim 1, further comprising:
receiving, from a user, a query message indicating the plaintext value, wherein querying the database comprises identifying the second ciphertext based at least in part on the plaintext value and the encryption function.

3. The method of claim 1, further comprising:
receiving, from the database, the first ciphertext based at least in part on querying the database.

4. The method of claim 3, further comprising:
decrypting the first ciphertext based at least in part on the encryption function.

5. The method of claim 1, wherein encrypting the normalized version of the plaintext value is based at least in part on a first encryption key, the method further comprising:
encrypting a second normalized version of the plaintext value based at least in part on the encryption function and a second encryption key;
sending a third ciphertext associated with the encrypted normalized version of the plaintext value to the database; and
querying the database for the plaintext value based at least in part on the third ciphertext.

6. The method of claim 1, further comprising:
receiving, from a user, a request to apply a case insensitive unicity requirement to a first data field of the database associated with the first ciphertext;
modifying the request, wherein the modified request applies the case insensitive unicity requirement to a second data field of the database associated with the second ciphertext; and
sending the case insensitive unicity requirement to the database.

7. The method of claim 1, wherein the encryption function is a deterministic encryption function.

8. A method for deterministic encryption, comprising:
storing, in a first data field, a first ciphertext associated with a first plaintext value;
receiving a second ciphertext associated with a second plaintext value, wherein the first ciphertext and the second ciphertext are encrypted using a deterministic encryption function;
identifying that the first ciphertext and the second ciphertext are the same; and
storing, in a second data field, a first unique identifier for the first ciphertext and a second unique identifier for the second ciphertext, wherein the first unique identifier and the second unique identifier distinguish between the first ciphertext and the second ciphertext.

9. The method of claim 8, further comprising:
storing, in the first data field, the second ciphertext.

10. The method of claim 8, wherein the first ciphertext is associated with a first encryption key and the second ciphertext is associated with a second encryption key.

11. The method of claim 10, further comprising:
storing, in the first data field, a third ciphertext associated with the first plaintext value and the second encryption key, wherein the third ciphertext and the second ciphertext are different; and
removing, from the first data field, the first ciphertext.

12. The method of claim 8, wherein the first data field is subject to a unicity requirement, the method further comprising:
applying the unicity requirement to a combination of the first data field and the second data field.

13. The method of claim 8, wherein the first data field comprises a case insensitive unicity requirement, the method further comprising:
storing, in a third data field, a fourth ciphertext associated with a normalized version of the first plaintext value, wherein the normalized version of the first plaintext value consists of lowercase characters; and
the method further comprising applying the case insensitive unicity requirement to the third data field.

14. An apparatus for deterministic encryption, comprising:
a processor;
memory in electronic communication with the processor; and
instructions stored in the memory and operable, when executed by the processor, to cause the apparatus to:
encrypt a plaintext value based at least in part on an encryption function, wherein the plaintext value comprises uppercase characters and lowercase characters;
send a first ciphertext associated with the encrypted plaintext value to a database;
encrypt a normalized version of the plaintext value based at least in part on the encryption function, wherein the normalized version of the plaintext value consists of lowercase characters;
send a second ciphertext associated with the encrypted normalized version of the plaintext value to the database; and
query the database for the plaintext value based at least in part on the second ciphertext.

15. The apparatus of claim 14, wherein the instructions are further executable by the processor to:
receive, from a user, a query message indicating the plaintext value, wherein querying the database comprises identifying the second ciphertext based at least in part on the plaintext value and the encryption function.

16. The apparatus of claim 14, wherein the instructions are further executable by the processor to:
receive, from the database, the first ciphertext based at least in part on querying the database.

17. The apparatus of claim 14, wherein encrypting the normalized version of the plaintext value is based at least in part on a first encryption key, and the instructions are further executable by the processor to:
encrypt a second normalized version of the plaintext value based at least in part on the encryption function and a second encryption key;
send a third ciphertext associated with the encrypted normalized version of the plaintext value to the database; and
querying the database for the plaintext value based at least in part on the third ciphertext.

18. An apparatus for deterministic encryption, comprising:
a processor;
memory in electronic communication with the processor; and
instructions stored in the memory and operable, when executed by the processor, to cause the apparatus to:
store, in a first data field, a first ciphertext associated with a first plaintext value;
receive a second ciphertext associated with a second plaintext value, wherein the first ciphertext and the second ciphertext are encrypted using a deterministic encryption function;
identify that the first ciphertext and the second ciphertext are the same; and
store, in a second data field, a first unique identifier for the first ciphertext and a second unique identifier for the second ciphertext, wherein the first unique identifier and the second unique identifier distinguish between the first ciphertext and the second ciphertext.

19. The apparatus of claim 18, wherein the first data field is subject to a unicity requirement, and the instructions are further executable by the processor to:
apply the unicity requirement to a combination of the first data field and the second data field.

20. The apparatus of claim 18, wherein the first data field comprises a case insensitive unicity requirement, and the instructions are further executable by the processor to:
store, in a third data field, a fourth ciphertext associated with a normalized version of the first plaintext value, wherein the normalized version of the first plaintext value consists of lowercase characters; and
apply the case insensitive unicity requirement to the third data field.
